(19) United States
(12) Patent Application Publication
(10) Pub. No.: US 2024/0101860 A1
(43) Pub. Date: Mar. 28, 2024

(54) COATING COMPOSITION

(71) Applicant: PPG Industries Ohio, Inc., Cleveland, OH (US)

(72) Inventors: Adam Bradley Powell, Jr., Wexford, PA (US); Elzen Kurpejovic, Rangendingen (DE); Fengshuo Hu, Mason, OH (US); Carl A. Seneker, Milford, OH (US); Wenchao Zhang, Mason, OH (US); Hongying Zhou, Allison Park, PA (US); Edward R. Millero, Jr., Gibsonia, PA (US); Dennis A. Simpson, Sarver, PA (US); Michael G. Olah, Pittsburgh, PA (US); Rudolf Baumgarten, Reutlingen (DE); Kareem Kaleem, Loveland, OH (US); Nigel F Masters, Essex (GB); William H. Retsch, Jr., Allison Park, PA (US)

(73) Assignee: PPG Industries Ohio, Inc., Cleveland, OH (US)

(21) Appl. No.: 18/263,383

(22) PCT Filed: Jan. 28, 2022
(86) PCT No.: PCT/US2022/014444

§ 371 Date: Jul. 28, 2023

Related U.S. Application Data
(60) Provisional application No. 63/143,081, filed on Jan. 29, 2021.

(51) Int. Cl. C09D 167/02; C09D 7/63; C09D 7/65

(52) U.S. Cl. CPC C09D 167/02; C09D 7/63; C09D 7/65; C08K 5/3155

(57) ABSTRACT

A coating composition comprising (a) a polyester binder material; and (b) a feathering reducing agent. The feathering reducing agent is selected from (i) an acrylic feathering reducing agent comprising a functional group selected from hydroxyl, epoxide, phosphatized epoxide and/or acid-functional; (ii) a hydroxy-functional polyester feathering reducing agent; (iii) a feathering reducing agent comprising a functional group selected from amine, amide, imine and/or nitrile; (iv) a phosphatized epoxy feathering reducing agent; (v) a phenolic resin feathering reducing agent; and/or (vi) a feathering reducing agent comprising an oxazolyl functional group. The invention extends to a substrate coated with the coating composition and use of the coating composition to reduce feathering.

### FIELD OF THE INVENTION

The present invention relates to a coating composition. In particular, the invention relates to a coating composition for food and/or beverage packaging. The present invention extends to articles coated with the coating composition and to methods of preparing and applying the coating composition.

### BACKGROUND OF THE INVENTION

Coatings are used in a wide variety of different applications. For example, many different coatings have been used to coat food and/or beverage packaging. Coating systems typically have certain properties such as being capable of high speed application, having acceptable adhesion to the substrate, being safe for food contact and having properties that are suitable for their end use. Typically, coatings have one, or maybe two, of these advantageous properties depending on their final end use.

### SUMMARY OF THE INVENTION

According to the present invention there is provided a coating composition comprising:
a. a polyester binder material; and
b. a feathering reducing agent, selected from
   i. an acrylic feathering reducing agent comprising a functional group selected from hydroxyl, epoxide, phosphatized epoxide and/or acid-functional;
   ii. a hydroxy-functional polyester feathering reducing agent;
   iii. a feathering reducing agent comprising a functional group selected from amine, amide, imine and/or nitrile;
   iv. a phosphatized epoxy feathering reducing agent;
   v. a phenolic resin feathering reducing agent; and/or
   vi. a feathering reducing agent comprising an oxazolyl functional group.

There is also provided a method of preparing a coating composition comprising contacting:
a. a polyester binder material; and
b. a feathering reducing agent, selected from
   i. an acrylic feathering reducing agent comprising a functional group selected from hydroxyl, epoxide, phosphatized epoxide and/or acid-functional;
   ii. a hydroxy-functional polyester feathering reducing agent;
   iii. a feathering reducing agent comprising a functional group selected from amine, amide, imine and/or nitrile;
   iv. a phosphatized epoxy feathering reducing agent;
   v. a phenolic resin feathering reducing agent; and/or
   vi. a feathering reducing agent comprising an oxazolyl functional group. to form a coating composition.

There is also provided a coated substrate comprising a coating extending over at least a part of the substrate, wherein the coating is obtainable from a coating composition comprising:
a. a polyester binder material; and
b. a feathering reducing agent, selected from
   i. an acrylic feathering reducing agent comprising a functional group selected from hydroxyl, epoxide, phosphatized epoxide and/or acid-functional;
   ii. a hydroxy-functional polyester feathering reducing agent;
   iii. a feathering reducing agent comprising a functional group selected from amine, amide, imine and/or nitrile;
   iv. a phosphatized epoxy feathering reducing agent;
   v. a phenolic resin feathering reducing agent; and/or
   vi. a feathering reducing agent comprising an oxazolyl functional group.
      optionally, wherein the coated portion of the substrate comprises a pretreatment layer, wherein the pretreatment layer is obtainable from a pretreatment composition that comprises a trivalent chromium compound.

There is also provided a method of coating at least a portion of a substrate, the method comprising:
a. contacting a coating composition with the substrate;
b. curing the coating composition on the substrate to form a coating;
wherein coating composition comprises:
a. a polyester binder material; and
b. a feathering reducing agent, selected from
   i. an acrylic feathering reducing agent comprising a functional group selected from hydroxyl, epoxide, phosphatized epoxide and/or acid-functional;
   ii. a hydroxy-functional polyester feathering reducing agent;
   iii. a feathering reducing agent comprising a functional group selected from amine, amide, imine and/or nitrile;
   iv. a phosphatized epoxy feathering reducing agent;
   v. a phenolic resin feathering reducing agent; and/or
   vi. a feathering reducing agent comprising an oxazolyl functional group.
      optionally wherein the coated portion of the substrate comprises a pretreatment layer, wherein the pretreatment layer is obtainable from a pretreatment composition that comprises a trivalent chromium compound.

There is also provided a package coated at least in part with a coating composition comprising:
a. a polyester binder material; and
b. a feathering reducing agent, selected from
   i. an acrylic feathering reducing agent comprising a functional group selected from hydroxyl, epoxide, phosphatized epoxide and/or acid-functional;
   ii. a hydroxy-functional polyester feathering reducing agent;
   iii. a feathering reducing agent comprising a functional group selected from amine, amide, imine and/or nitrile;
   iv. a phosphatized epoxy feathering reducing agent;
   v. a phenolic resin feathering reducing agent and/or
   vi. a feathering reducing agent comprising an oxazolyl functional group.
      optionally wherein the coated portion of the substrate comprises a pretreatment layer, wherein the pretreatment layer is obtainable from a pretreatment composition that comprises a trivalent chromium compound.

There is also provided a package, such as a metal can, coated at least in part on an end thereof with a coating composition comprising:
a. a polyester binder material; and
b. a feathering reducing agent, selected from
   i. an acrylic feathering reducing agent comprising a functional group selected from hydroxyl, epoxide, phosphatized epoxide and/or acid-functional;
   ii. a hydroxy-functional polyester feathering reducing agent;
   iii. a feathering reducing agent comprising a functional group selected from amine, amide, imine and/or nitrile;
   iv. a phosphatized epoxy feathering reducing agent;
   v. a phenolic resin feathering reducing agent; and/or
   vi. a feathering reducing agent comprising an oxazolyl functional group.
      optionally wherein the coated portion of the substrate comprises a pretreatment layer, wherein the pretreatment layer is obtainable from a pretreatment composition that comprises a trivalent chromium compound.

There is also provided a method of reducing feathering, comprising applying a coating composition comprising:
a. a polyester binder material; and
b. a feathering reducing agent, selected from
   i. an acrylic feathering reducing agent comprising a functional group selected from hydroxyl, epoxide, phosphatized epoxide and/or acid-functional;
   ii. a hydroxy-functional polyester feathering reducing agent;
   iii. a feathering reducing agent comprising a functional group selected from amine, amide, imine and/or nitrile;
   iv. a phosphatized epoxy feathering reducing agent;
   v. a phenolic resin feathering reducing agent; and/or
   vi. a feathering reducing agent comprising an oxazolyl functional group.
      to at least a part of the substrate to form a coating, optionally wherein the coated portion of the substrate comprises a pretreatment layer, wherein the pretreatment layer is obtainable from a pretreatment composition that comprises a trivalent chromium compound.

### DETAILED DESCRIPTION OF THE INVENTION

When a can is opened, such as by using a tab, if feathering occurs a portion of the film will be present extending into the opening of the can. For example, this can occur with beverage cans having a pull tab or a can having a full aperture EOE. Feathering is an undesirable phenomenon from a safety perspective due to potential ingestion of the coating.

It has been found that this phenomenon is particularly evident with hexavalent chromium-free substrates, such as with trivalent chromium pre-treated substrates. Advantageously, it has been found that the use of the herein defined feathering reducing agents in the defined compositions reduce feathering in the packaging, such as on trivalent chromium pre-treated substrates.

As used herein, a ‘feathering reducing agent’ reduces feathering in a coating formed from a coating composition comprising the feathering reducing agent compared to the same composition not containing the feathering reducing agent. ‘Feathering’ as referred to herein, was measured by the following test protocol 1:

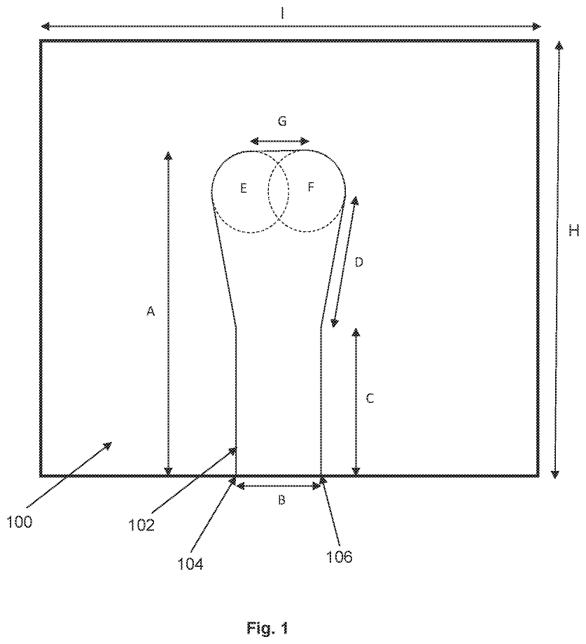

A trivalent chromium pretreated aluminium panel having a thickness of 0.21 mm was coated with a coating composition to give a film weight 7.0 mg/in². The panel was then baked in a three zone coil oven to a peak metal temperature of 240° C. The panel was then cut into a 50.8 mm by 88.9 mm piece, with the substrate grain running perpendicular to the long length of the cut panel. The test panel coated side up was then inserted between the score tool and the anvil in a Carver press. The long edge of the panel was abutted against the guide block on the inside of the press. The valve on the base of the press was tightened to clamp the panel into the Carver press. A force of 1500 psi on the hydraulic pressure gauge was applied to make the score line of a simulated tab. The depth of the score line was 0.18 mm. Shown in FIG. 1 is a schematic of the coated panel (100) comprising the score line of the simulated tab (102). The simulated tab (102) extended perpendicularly to the long length (l) of the panel. The terminal points (104, 106) of the score line (which collectively form the front of the simulated tab, i.e. the portion of the tab that was first opened) were both arranged at an edge of the long length (l) of the panel. The dimensions of the simulated tab (102) were: A (48.0 mm); B (11.3 mm); C (24.0 mm); D (18.00 mm); E and F area (89.4 mm²); and G (10.6 mm). Lengths D extended from the upper terminal point of respective length C to the left and right vertex of circles E and F, respectively. Length G extended between the upper vertex of circles E and F. The panel was then removed from the press and two spaced parallel cuts were formed in the panel at the front end of the simulated tab along the score line. Each cut extended inward into the panel, perpendicularly to the long length, starting from the terminal points (104 and 106) of the score line. The cuts extended 6.4 mm into the panel along the respective portion of the score line and were spaced 11.3 mm apart. The panel was then fully immerged into deionized water for 30 minutes at 250° F. (121° C.). The panel was then removed and immediately submerged in 22° C. DI water for 2 seconds. The panel was then removed from the deionized water. The cut portion of the simulated tab was bent 1800 toward the coated face of the panel. The panel was then inserted into a vice where the panel was held along the long length, with the edge from which the score line extended being held in the vice. Pliers were then used to grip the cut portion of the simulated tab and then to pull the cut portion of the tab 180° across the coated face of the panel toward the opposite end of the tab at a rate of 1 second/cm. Feathering was then measured using a digital Microscope. The length of the coating that extended furthest into the tab opening was measured in mm and recorded.

The feathering reducing agent may reduce feathering in a coating formed from a coating composition comprising the feathering reducing agent compared to the same composition not containing the feathering reducing agent by at least 20%, such as at least 30% or at least 40%, as measured by the above-mentioned test protocol 1.

A coating formed from the coating composition may have feathering of ≤0.8 mm, as measured by the above-mentioned test protocol 1, such as ≤0.5 mm, ≤0.4 mm or ≤0.35 mm.

The coated substrate or package may have feathering of ≤0.8 mm when a portion of the coated substrate or package is separated from the remainder of the coated substrate or package, such as ≤0.5 mm, ≤0.4 mm or ≤0.35 mm, wherein the length of the coating that extends furthest into the opening created by separating the portion of the coated substrate or package is measured in mm using a digital Microscope to record the feathering. The said removable portion may be a portion of the coated substrate or package that is intended to be removed or separated from the remainder of the coated substrate or package in use, such as a tab in a beverage can.

A coating formed from coating composition, the coated substrate or the package may have a wedge bend of 30 mm, such as ≤25 mm or ≤20 mm.

As reported herein, the wedge bend was measured as follows. A coated panel was obtained by drawing the coating composition over trivalent chromium pretreated NR6207 aluminum panels (AA5182 Alloy) using a wire wound rod to obtain dry coating weight of approximately 6.5 to 7.5 mg/square inch (msi). The coated panel was then immediately placed into a three-zone, gas-fired, conveyor oven for 10 seconds and baked to a peak metal temperature of 465° F. (240.5° C.).Coated panels were cut into 2 inch by 4 inch pieces, with the substrate grain running perpendicular to the long length of the cut panel. They were then bent over a ⅛ inch metal rod along the long length of the panel with the coated side facing out. Bent coupons were then placed onto a block of metal where a wedge was pre-cut out of it with a taper of 0 to ⅛ inch along a 4 inch length. Once placed in the wedge, each bent coupon was struck with a block of metal which weighed 4 pounds from a height of 12 inches to form a wedge where one end of the coated metal impinged upon itself and a ⅛ inch space remained on the opposite end. Wedge bent panels were then placed into an aqueous solution of copper sulfate and hydrochloric acid for one minute to purposely etch the aluminum panel in areas where the coatings failed and cracked. The etched wedge bent panels were then examined through a microscope at 10× power to determine how far from the impinged end along the bent radii did the coating crack. Flexibility results are reported as either the length of cracked area from the impinged end.

A coating formed from coating composition, the coated substrate or the package may have a blush of ≥4, such as ≥6 or ≥7.

As reported herein, blush was measured as follows. A coated panel was obtained by drawing the coating composition over trivalent chromium pretreated NR6207 aluminum panels (AA5182 Alloy) using a wire wound rod to obtain dry coating weight of approximately 6.5 to 7.5 mg/square inch (msi). The coated panel was then immediately placed into a three-zone, gas-fired, conveyor oven for 10 seconds and baked to a peak metal temperature of 465° F. (240.5° C.). The coated panel was then cut into 2 inch by 4 inch pieces, half immersed into deionized water, and then placed in a steam retort for 30 minutes at 250° F. The panel was then cooled in deionized water, dried, and immediately rated for blush and adhesion. Blush was rated visually using a scale of 1-10 where a rating of “10” indicates no blush and “0” indicates complete whitening of the film.

A coating formed from coating composition, the coated substrate or the package may have an adhesion of ≥90, such as ≥95 or ≥99%.

As reported herein, adhesion was measured according to ASTM D 3359 Test Method B using Scotch 610 tape, and rated using a scale of 0-100% where a rating of “100%” indicates no adhesion failure and “0” indicates complete adhesion failure. The coated panel was obtained by drawing the coating composition over trivalent chromium pretreated NR6207 aluminum panels (AA5182 Alloy) using a wire wound rod to obtain dry coating weight of approximately 6.5 to 7.5 mg/square inch (msi). The coated panel was then immediately placed into a three-zone, gas-fired, conveyor oven for 10 seconds and baked to a peak metal temperature of 465° F. (240.5° C.).

The coating composition may comprise any suitable liquid carrier. The coating compositions may comprise a single liquid carrier or a mixture of carriers. The liquid carrier may comprise water, an organic solvent, a mixture of water and an organic solvent or a mixture of organic solvents.

The coating composition may be an aqueous coating composition. An aqueous coating composition may represent a coating composition obtainable by dissolving and/or dispersing the film-forming resin in an aqueous medium. An aqueous coating composition may be a coating composition comprising at least 10% water by total liquid carrier weight, such as at least 30 wt % or at least 50 wt %.

The coating composition may be an organic solventborne coating composition, An organic solventborne coating composition may be a coating composition comprising more than 90% organic solvent by total liquid carrier weight, such as at least 95 wt %.

The organic solvent may have a sufficient volatility to essentially entirely evaporate from the coating composition during the curing process.

Suitable organic solvents include, but are not limited to the following: aliphatic hydrocarbons such as mineral spirits and high flash point naphtha; aromatic hydrocarbons such as benzene; toluene; xylene; solvent naphtha 100, 150, 200; those available from Exxon-Mobil Chemical Company under the SOLVESSO® trade name; alcohols such as ethanol; n-propanol; isopropanol; isobutanol and n-butanol; ketones such as acetone; cyclohexanone; methylisobutyl ketone; methyl ethyl ketone; esters such as ethyl acetate; butyl acetate; n-hexyl acetate; RHODIASOLV® RPDE (a blend of succinic and adipic esters commercially available from Solvay); glycols such as butyl glycol; glycol ethers such as methoxypropanol; ethylene glycol monomethyl ether; ethylene glycol monobutyl ether; dipropylene glycol methyl ether (Dowanol DPM) and combinations thereof.

The liquid carrier, when present, may be used in the coating composition in an amount of ≥5%, such ≥10%, such as ≥20%, or ≥30%, or even ≥50% based on the total weight of the coating composition. The liquid carrier, when present, may be used in the coating composition in an amount of ≤90%, such as ≤80%, such as ≤75%, or even ≤70% based on the total weight of the coating composition. The liquid carrier, when present, may be used in the coating composition in amounts from 5 to 90%, such as from 10 to 80%, such as from 20 to 75%, or even from 30 to 70% based on the total weight of the coating composition. The liquid carrier, when present, may be used in the coating composition in amounts from 50 to 70 wt % based on the total weight of the coating composition.

The polyester binder material may comprise a polyester obtainable by polymerizing a polyacid component with a polyol component, or by ring opening polymerization, such as ring opening polymerization of a lactone component and/or an epoxy component. The polyester material may comprise a saturated polyester. “Polyester material” when used herein includes copolymers of a polyacid and a polyol, and also includes polyesters that have been modified, such as polyesters that are modified by grafting a further polymer onto the polyester. Examples of modified polyesters include an acrylic modified polyester resin.

“Polyacid” and like terms as used herein, refers to a compound having two or more carboxylic acid groups, such as two (diacids), three (triacids) or four acid groups, and includes an ester of the polyacid (wherein an acid group is esterified) or an anhydride. The polyacid may be an organic polyacid.

The carboxylic acid groups of the polyacid may be connected by a bridging group selected from: an alkylene group; an alkenylene group; an alkynylene group; or an arylene group.

The polyester material may be formed from any suitable polyacid. Suitable examples of polyacids include, but are not limited to the following: maleic acid; fumaric acid; itaconic acid; adipic acid; azelaic acid; succinic acid; sebacic acid; glutaric acid; decanoic diacid; dodecanoic diacid; phthalic acid; isophthalic acid; 5-tert-butylisophthalic acid; tetrachlorophthalic acid; tetrahydrophthalic acid; trimellitic acid; naphthalene dicarboxylic acid; naphthalene tetracarboxylic acid; terephthalic acid; hexahydrophthalic acid; methylhexahydrophthalic acid; dimethyl terephthalate; cyclohexane dicarboxylic acid; chlorendic anhydride; 1,3-cyclohexane dicarboxylic acid; 1,4-cyclohexane dicarboxylic acid; tricyclodecane polycarboxylic acid; endomethylene tetrahydrophthalic acid; endoethylene hexahydrophthalic acid; cyclohexanetetra carboxylic acid; cyclobutane tetracarboxylic; a monomer having an aliphatic group containing at least 15 carbon atoms; esters and anhydrides of all the aforementioned acids and combinations thereof.

The polyacid component may comprise a diacid. Suitable examples of diacids include, but are not limited to the following: phthalic acid; isophthalic acid; terephthalic acid; 1,4 cyclohexane dicarboxylic acid; succinic acid; adipic acid; azelaic acid; sebacic acid; fumaric acid; 2,6-naphthalene dicarboxylic acid; orthophthalic acid; phthalic anhydride; tetrahydrophthalic acid; hexahydrophthalic acid; maleic acid; succinic acid; itaconic acid; di-ester materials, such as dimethyl ester derivatives for example dimethyl isophthalate, dimethyl terephthalate, dimethyl 1,4-cyclohexane dicarboxylate, dimethyl 2,6-naphthalene di carboxylate, dimethyl fumarate, dimethyl orthophthalate, dimethylsuccinate, dimethyl glutarate, dimethyl adipate; a monomer having an aliphatic group containing at least 15 carbon atoms; esters and anhydrides of all the aforementioned acids; and mixtures thereof.

The polyacid component may comprise: terephthalic acid (TPA), dimethyl terephthalate, isophthalic acid (IPA), dimethyl isophthalic acid, 1,4 cyclohexane dicarboxylic acid, hexahydrophthalic anhydride, 2,6-naphthalene dicarboxylic acid, phthalic anhydride, maleic anhydride, fumaric anhydride; and/or a monomer having an aliphatic group containing at least 15 carbon atoms.

The polyacid component may comprise: terephthalic acid, isophthalic acid, dimethyl terephthalate, hexahydrophthalic anhydride, cyclohexane 1,4-dicarboxylic acid, maleic anhydride, and/or a monomer having an aliphatic group containing at least 15 carbon atoms.

The polyol component comprises a polyol. “Polyol” and like terms, as used herein, refers to a compound having two or more hydroxyl groups, such as two (diols), three (triols) or four hydroxyl groups (tetrols). The hydroxyl groups of the polyol may be connected by a bridging group selected from: an alkylene group; an alkenylene group; an alkynylene group; or an arylene group. The polyol may be an organic polyol.

The polyester material may be formed from any suitable polyol. Suitable examples of polyols include, but are not limited to the following: alkylene glycols, such as ethylene glycol; propylene glycol; diethylene glycol; dipropylene glycol; triethylene glycol; tripropylene glycol; hexylene glycol; polyethylene glycol; polypropylene glycol and neopentyl glycol; hydrogenated bisphenol A; cyclohexanediol; propanediols including 1,2-propanediol; 1,3-propanediol; butyl ethyl propanediol; 2-methyl-1,3-propanediol; and 2-ethyl-2-butyl-1,3-propanediol; butanediols including 1,4-butanediol; 1,3-butanediol; and 2-ethyl-1,4-butanediol; pentanediols including trimethyl pentanediol and 2-methylpentanediol; cyclohexanedimethanol; hexanediols including 1,6-hexanediol; 2,2,4,4-tetraalkylcyclobutane-1,3-diol (TACD), such as 2,2,4,4-tetramethylcyclobutane-1,3-diol (TMCD), 2,2,4-trimethyl-1,3-pentanediol (TMPD), caprolactonediol (for example, the reaction product of a reaction mixture comprising epsilon-capro lactone and ethylene glycol); hydroxyalkylated bisphenols; polyether glycols, for example, poly(oxytetramethylene) glycol; trimethylol propane; pentaerythritol; di-pentaerythritol; trimethylol ethane; trimethylol butane; dimethylol cyclohexane; bio-derived polyols such as glycerol, sorbitol and isosorbide; a monomer having an aliphatic group containing at least 15 carbon atoms; and the like or combinations thereof.

The diols may be selected from: ethylene glycol; 1,2-propane diol; 1,3-propane diol; 1,2-butandiol; 1,3-butandiol; 1,4-butandiol; but-2-ene 1,4-diol; 2,3-butane diol; 2-methyl 1,3-propane diol; 2,2′-dimethyl 1,3-propanediol (neopentyl glycol); 1,5 pentane diol; 3-methyl 1,5-pentanediol; 2,4-diethyl 1,5-pentane diol; 1,6-hexane diol; 2-ethyl 1,3-hexane diol; 2,2,4,4-tetraalkylcyclobutane-1,3-diol (TACD), such as 2,2,4,4-tetramethylcyclobutane-1,3-diol (TMCD), 2,2,4-trimethyl-1,3-pentanediol (TMPD), diethylene glycol; triethylene glycol; dipropylene glycol; tripropylene glycol; 1,4 cyclohexane dimethanol; tricyclodecane dimethanol; isosorbide; 1,4-cyclohexane diol; and/or 1, 1′-isopropylidene-bis (4-cyclohexanol); and mixtures thereof.

The polyol component may comprise a polyol having at least three hydroxyl groups, such as trimethylol propane; pentaerythritol; di-pentaerythritol; trimethylol ethane; trimethylol butane; and/or bio-derived polyols such as glycerol and/or sorbitol. The polyol component having at least three hydroxyl groups may comprise a triol or tetrol, such as trimethylol propane; pentaerythritol; trimethylol ethane; trimethylol butane and/or glycerol. The polyol component having at least three hydroxyl groups may comprise a triol, such as trimethylol propane; trimethylol ethane; and/or trimethylol butane, for example trimethylol propane.

The polyol having at least three hydroxyl groups may be present as a proportion of the solid weight of the polyol component in an amount of ≥0.1 wt %, such as ≥0.5 wt % or ≥0.7 wt %, for example ≥0.8 wt % or ≥0.9 wt %, such as ≥1 wt %.

The polyol having at least three hydroxyl groups may be present as a proportion of the solid weight of the polyol component in an amount of ≤10 wt %, such as ≤8 wt % or ≤6 wt %, for example ≤5 wt % or ≤4 wt %, such as ≤3 wt % or ≤2 wt %.

The polyol having at least three hydroxyl groups may be present as a proportion of the solid weight of the polyol component in an amount of from 0.1 to 10 wt %, such as from 0.5 to 8 wt % or from 0.7 to 6 wt %, for example from 0.8 to 5 wt % or from 0.9 to 4 wt %, such as from 1 to 3 wt % or from 1 to 2 wt %.

In particular the polyol component may comprise ethylene glycol (EG), 1,2-propylene glycol (PG), 2-methyl propanediol (2-MPD), neopentyl glycol (NPG), 1,4-cyclohexane dimethanol (CHDM), butyl ethyl propane diol (BEPD), trimethylolpropane (TMP) and/or 1,6 hexanediol.

Further details of such a monomer having an aliphatic group containing at least 15 carbon atoms are disclosed in published PCT patent application WO 2018/111854, specifically, paragraphs [016] to [030] inclusive. The entire contents of WO 2018/111854 and specifically paragraphs [016] to [030] inclusive thereof are fully incorporated herein by reference.

The polyacid component and/or the polyol component may comprise a sulfonated monomer. The sulfonated monomer may comprise a sulfonated diacid, such as a sulfonated aromatic diacid. The sulfonated monomer may comprise a salt thereof, such as an inorganic salt, for example a metal or ammonium salt. Examples of metal salts would include, for example sodium salts, lithium salts, potassium salts, magnesium salts, calcium salts, iron salts etc.

The polyacid component may comprise a sulfonated monomer. Alternatively, the polyacid component may be substantially free of sulfonated monomer.

The sulfonated monomer may comprise a metal salt of 5-(sulfo)-isopthalic acid, such as the sodium salt thereof, referred to as 5-(sodiosulfo)-isophthalic acid, also referred to herein as 5-SSIPA.

The sulfonated monomer may comprise: 5-(sodiosulfo)-isophthalic acid, dimethyl 5-(sodiosulfo)isophalate, 5-(lithiosulfo)isophthalic acid, and/or bis(2-hydroxyethyl)-5-(sodiosulfo)isophthalate.

Where the sulfonated monomer is a polyacid, the sulfonated monomer may be present as a proportion of the solid weight of the polyacid component in an amount of from 5 to 20 wt %, such as 7 to 15 wt %.

Where the sulfonated monomer is a polyol, the sulfonated monomer may be present as a proportion of the solid weight of the polyol component in an amount of from 5 to 20 wt %, such as 7 to 15 wt %.

The polyester binder material may comprise an acrylic polyester resin, which may be a polyester resin having an acrylic polymer grafted thereonto.

The acrylic polyester resin may be obtainable by grafting an acrylic polymer and a polyester resin, wherein the polyester resin is obtainable by polymerizing:
i) a polyacid component, such as defined above with
ii) a polyol component, such as defined above
   and wherein one of the polyacid component or the polyol component comprises a functional monomer operable to impart functionality on to the polyester resin, such that an acrylic polymer may be grafted with the polyester resin via the use of said functionality.

The polyacid component or the polyol component of the polyester resin of the acrylic polyester resin comprises a functional monomer operable to impart functionality to the polyester resin. The functionality is such that an acrylic polymer may be grafted onto the polyester resin via the use of said functionality. The functionality may comprise ethylenic unsaturation, carboxylic acid functionality or epoxy functionality. The functionality may be in the backbone of the polyester resin or pendant therefrom.

The functional monomer may comprise an ethylenically unsaturated monomer, which ethylenically unsaturated monomer may be operable to impart ethylenically unsaturated functionality on the backbone of the polyester resin, or pendant therefrom. The functionality may comprise ethylenic unsaturation, which may be in the backbone of the polyester resin.

Suitable functional monomers comprise: maleic acid, maleic anhydride, fumaric acid, itaconic anhydride, itaconic acid, citraconic anhydride, citraconic acid, aconitic acid, aconitic anhydride, oxalocitraconic acid, oxalocitraconic anhydride, mesaconic acid, mesaconic anhydride, phenyl maleic acid, phenyl maleic anhydride, t-butyl maleic acid, t-butyl maleic anhydride, monomethyl fumarate, monobutyl fumarate, nadic acid, nadic anhydride, methyl maleic acid, methyl maleic anhydride, and/or trimethylolpropane monoallyl ether.

Where the functional monomer comprises a polyacid, the functional monomer may be present as a proportion of the solid weight of the polyacid component in an amount of from 0.5 to 10 wt %, such as from 1 to 5 wt %.

Where the functional monomer comprises a polyol, the functional monomer may be present as a proportion of the solid weight of the polyol component in an amount of from 0.5 to 10 wt %, such as from 1 to 5 wt %.

The functional monomer of the polyester resin of the acrylic polyester resin may comprise maleic acid, maleic anhydride and/or fumaric acid.

The polyester resin of the acrylic polyester resin may be modified with acrylic by grafting an acrylic modification polymer onto the polyester resin. This grafting may occur via free radical polymerization, such as by free radical polymerization onto ethylenic unsaturation on the polyester material.

The acrylic modification polymer may be formed from acrylic monomers. The acrylic modification polymer may be grafted onto the polyester resin by polymerizing acrylic monomers in the presence of the polyester material to form the acrylic polyester resin.

Various acrylic monomers can be combined to prepare the acrylic modification polymer. Examples include methyl(meth)acrylate, ethyl(meth)acrylate, butyl(meth)acrylate, cyclohexyl (meth) acrylate; allyl (meth)acrylate; isobornyl (meth)acrylate, hydroxyethyl (meth)acrylate, 2-ethylhexyl(meth)acrylate, (meth)acrylic acid, dimethylamino ethyl methacrylate, butylamino ethyl (meth)acrylate, and/or HEMA phosphate (such as ethylene glycol methacrylate phosphate). Any other acrylic monomers known to those skilled in the art could also be used.

The term “(meth) acrylate” and like terms are used conventionally and herein to refer to both methacrylate and acrylate.

A suitable acrylic modification polymer is formed from monomers comprising: methyl (meth)acrylate, ethyl(meth)acrylate, butyl (meth)acrylate, hydroxyethyl (meth)acrylate, (meth)acrylic acid, cyclohexyl (meth)acrylate, allyl (meth)acrylate, dimethylamino ethyl methacrylate. butylamino ethyl (meth)acrylate, and/or HEMA phosphate (such as ethylene glycol methacrylate phosphate).

The acrylic monomers may comprise a ratio of methacrylate monomers to acrylate monomers of at least 1:1, such as at least 2:1 or at least 3:1 or at least 4:1, such as at least 5:1. The acrylic monomers may be substantially free of acrylate monomers. By “methacrylate monomers” and “acrylate monomers” with regard to the ratio of these types of monomers in the acrylic monomers of the acrylic modification polymer, it is meant the total number of methacrylate monomers compared to the total number of acrylate monomers across all the types of acrylic monomer that form the acrylic modification polymer. For example, if the acrylic modification polymer is formed of methylmethacrylate, methyl acrylate and butyl acrylate, then the amount of methylmethacrylate compared to the combined amount of methyl acrylate and butyl acrylate would be at least 5:1.

The acrylic monomers may comprise a hydroxyl functional monomer, such as hydroxyethyl (meth)acrylate. The hydroxyl functional monomer may be present by solid weight of the acrylic modification polymer in an amount of from 5 to 40 wt %, such as from 5 to 30 wt % or from 10 to 20 wt %.

The acrylic modification polymer may also comprise an amount (such as 0 to 30 wt %, by solid weight of the acrylic modification polymer) of non-acrylic monomers. Such non acrylic monomers may include other ethylenically unsaturated monomers, such as styrene, ethylene, propylene, vinyl toluene, butadiene, 1-octene or isoprene, vinyl esters such as vinyl acetate, and/or nitriles such as (meth)acrylonitrile.

It has been identified that the acrylic modification polymer may include meth acrylic acid or acrylic acid to impart acid functionality on the acrylic modification polymer. The acid functionality on the acrylic modification polymer may be at least partially neutralised with a neutralisation agent.

The Tg of the acrylic modification polymer (which is a measure of the Tg of the acrylic modification polymer, polymerized as a simple acrylic polymer, not in the presence of (or grafted onto) a polyester resin) may be from 20 to 120° C. The Tg of the acrylic modification polymer can be calculated by the Fox equation as provided in “Coatings of Polymers and Plastics”, Ryntz R. A. and Yaneff P. V, CRC Press, 4 Feb. 2003, page 134.

Suitable neutralisation agents include ammonia or amine functional moieties: methyl ethanolamine, dimethylethanolamine (DMEA), trimethylamine, diethylene triamine.

The acid functionality on the acrylic modification polymer may be at least 30% neutralised with a neutralisation agent. The acid functionality on the acrylic modification polymer may be at least 50% neutralised with a neutralisation agent. The acid functionality on the acrylic modification polymer may be at least 75% neutralised with a neutralisation agent.

The acrylic polyester resin may be formed from the polyester resin and the acrylic modification polymer in a weight ratio of from 99 wt % to 50 wt % polyester resin to from 50 wt % to 1 wt % acrylic modification polymer, such as a weight ratio of from 95 wt % to 60 wt % polyester resin to from 40 wt % to 5 wt % acrylic modification polymer, such as a weight ratio of from 90 wt % to 65 wt % polyester resin to from 35 wt % to 10 wt % acrylic modification polymer. For example, the acrylic polyester resin may be formed from the polyester resin and the acrylic modification polymer in a weight ratio of 85 wt % polyester resin to 15 wt % acrylic polymer.

The polyester binder material may be prepared in the presence of an esterification catalyst. The esterification catalyst may be chosen to promote the reaction of components by esterification and/or trans-esterification. Suitable examples of esterification catalysts for use in the preparation of the high Mn polyester include, but are not limited to the following: metal compounds such as stannous octoate; stannous chloride; butyl stannoic acid (hydroxy butyl tin oxide); monobutyl tin tris (2-ethylhexanoate); chloro butyl tin dihydroxide; dibutyl tin oxide; tetra-n-propyl titanate; tetra-n-butyl titanate; zinc acetate; acid compounds such as phosphoric acid; para-toluene sulphonic acid; dodecyl benzene sulphonic acid (DDBSA), tetra alkyl zirconium materials, antimony trioxide, germanium dioxide, bismuth octoate and combinations thereof. The esterification catalyst may be dodecyl benzene sulphonic acid (DDBSA). The esterification catalyst may be dibutyl tin oxide or stannous octoate.

The esterification catalyst, when present, may be used in amounts from 0.001 to 1% by weight of the total polymer components, such as from 0.01 to 0.2%, such as from 0.025 to 0.2% by weight of the total polymer components.

The polyester material may have any suitable number-average molecular weight (Mn). The polyester material may have a Mn of ≥1,000 Daltons (Da=g/mole), such as ≥2,000 Da, such as ≥3,000 Da, or even ≥4,000 Da. The polyester material may have a Mn of ≤35,000 Da, such as ≤30,000 Da, such as ≤25,000 Da, or even ≤22,000 Da. The polyester material may have an Mn from 1,000 Da to 35,000 Da, such as from 2,000 Da to 30,000 Da, such as from 3,000 Da to 25,000 Da, or even from 4,000 to 22,000 Da.

As reported herein, the Mn and Mw were determined by gel permeation chromatography using a polystyrene standard according to ASTM D6579-11 (“Standard Practice for Molecular Weight Averages and Molecular Weight Distribution of Hydrocarbon, Rosin and Terpene Resins by Size Exclusion Chromatography”. UV detector; 254 nm, solvent: unstabilised THF, retention time marker: toluene, sample concentration: 2 mg/ml).

The polyester material and/or a coating formed from the coating composition may have any suitable glass transition temperature (Tg). The polyester material and/or a coating formed from the coating composition may have a Tg of ≥25° C. and/or ≤200° C. The polyester material and/or a coating formed from the coating composition may have a Tg of ≥250, or ≥30° C., or ≥35° C., such as ≥40° C. or ≥45° C., or ≥50° C., such as ≥55° C. or ≥60° C. The polyester material and/or a coating formed from the coating composition may have a Tg of ≤200° C. such as ≤150° C., or ≤120° C., or ≤110° C., or ≤105° C. The polyester material and/or a coating formed from the coating composition may have a Tg of from 25° C. to 200° C., such as from 40° C. to 150° C., such as from 50° C. to 120° C., or from 50° C. to 110° C., such as from 60° C. to 105° C.

As reported herein, the Tg was measured according to ASTM D6604-00(2013) (“Standard Practice for Glass Transition Temperatures of Hydrocarbon Resins by Differential Scanning Calorimetry”. Heat-flux differential scanning calorimetry (DSC), sample pans: aluminium, reference: blank, calibration: indium and mercury, sample weight: 10 mg, heating rate: 20° C./min).

The polyester material may have any suitable gross hydroxyl value (OHV). The polyester material may have a gross OHV from 0 to 120 mg KOH/g, such as from 0 to 70 KOH/g, or from 0 to 40 KOH/g, or from 0 to 20 KOH/g or from 0 to 15 KOH/g.

The gross OHV, is suitably expressed on solids.

As reported herein, the hydroxyl value is the number of mg of KOH equivalent to the hydroxyl groups in 1 g of material. A sample of solid polyester (0.13 g) was weighed accurately into a conical flask and dissolved, using light heating and stirring as appropriate, in 20 ml of tetrahydrofuran. 10 ml of 0.1M 4-(dimethylamino)pyridine in tetrahydrofuran (catalyst solution) and 5 ml of a 9 vol % solution of acetic anhydride in tetrahydrofuran (i.e. 90 ml acetic anhydride in 910 ml tetrahydrofuran; acetylating solution) were then added to the mixture. After 5 minutes, 10 ml of an 80 vol % solution of tetrahydrofuran (i.e. 4 volume parts tetrahydrofuran to 1 part distilled water; hydrolysis solution) was added. After 15 minutes, 10 ml tetrahydrofuran was added and the solution was titrated with 0.5M ethanolic potassium hydroxide (KOH). A blank sample was also run where the sample of solid polyester was omitted. The resulting hydroxyl number is expressed in units of mg KOH/g and is calculated using the following equation:

$$Hydroxyl value = \frac{\begin{matrix}\begin{matrix}( {V}_{2} - {V}_{1} ) \times \\ molarity of KOH solution ( M ) \times \end{matrix} \\ 56.1\end{matrix}}{weight of solid sample ( g )}$$

wherein V₁ is the titre of KOH solution (ml) of the polyester sample and V is the titre of KOH solution (ml) of the blank sample. All values for gross hydroxyl value reported herein were measured in this way.

The polyester material may have any suitable acid value (AV). The polyester material may have an AV of ≥3 KOH/g, such as ≥6 KOH/g, or ≥9 KOH/g. The polyester material may have an AV of ≤50 KOH/g, such as ≤40 KOH/g, or ≤30 KOH/g, or ≤25 KOH/g. The polyester material may have an AV of from 0 to 50 KOH/g, such as from 3 to 40 KOH/g, or from 6 to 30 KOH/g, or from 9 to 25 KOH/g.

The AV is suitably expressed on solids.

As reported herein, the AV was determined by titration with 0.1M methanolic potassium hydroxide (KOH) solution. A sample of solid polyester (0.1 g) was weighed accurately into a conical flask and dissolved, using light heating and stirring as appropriate, in 25 ml of dimethyl formamide containing phenolphthalein indicator. The solution was then cooled to room temperature and titrated with the 0.1M methanolic potassium hydroxide solution. The resulting acid number is expressed in units of mg KOH/g and is calculated using the following equation:

Acid number=titre of KOH solution (ml)×molarity KOH solution(M)×56.1 weight of solid sample (g)

All values for acid number reported herein were measured in this way.

The composition may comprise ≥40% of the polyester material by total solid weight of the composition, such as ≥50 wt %, or ≥60 wt %. The composition may comprise ≤99.9% of the polyester material by total solid weight of the composition, such as ≤99.5%, or 99%, or ≤98%, or ≤97 wt %, or ≤96 wt %. The composition may comprise from 40 to 99.9% of the polyester material by total solid weight of the composition, such as from 50 to 98%, or from 60 to 96%.

The coating composition may comprise an acrylic feathering reducing agent (i) comprising a functional group selected from hydroxyl, epoxide, phosphatized epoxide and/or acid-functional.

The acrylic feathering reducing agent (i) may be in the form of an acrylic (co)polymer formed from monomers that comprise an acrylic monomer, such as a (hetero)aliphatic (alk)acrylate or (alk)acrylic acid, optionally with another vinyl monomer, such as another acrylic monomer. Suitable acrylic monomers include, but are not limited to, alkyl (alk)acrylate, such as C₁ to C₆ alkyl (C₁ to C₆ alk)acrylate, for example, C₁ to C₆ alkyl (meth)acrylate, and (alk)acrylic acid, such as (C₁ to C₆ alk)acrylic acid. The acrylic monomers may comprise a functional group.

The acrylic monomer may be selected from (meth)acrylic acid, methyl (meth)acrylate, ethyl (meth)acrylate; propyl (meth)acrylate; butyl (meth)acrylate; cyclohexyl (meth)acrylate; benzyl methacrylate; 2-ethylhexyl (meth)acrylate; isobornyl (meth)acrylate; lauryl (meth)acrylate; hydroxyl-functional acrylates such as hydroxyethyl (meth)acrylate, hydroxypropyl (meth)acrylate, hydroxybutyl (meth)acrylate, and/or phosphates thereof, such as ethylene glycol methacrylate phosphate; and/or glycidyl-functional acrylates such as glycidyl (meth)acrylate.

The terms “(alk)acrykate”, “(meth)acrylate” and like terms as used herein are used conventionally and herein to refer to both alkacrylate and acrylate, such as methacrylate and acrylate.

Other vinyl monomers may be selected from (meth)acrylonitrile; vinyl ether, such as vinyl butyl ether; styrene, vinyl toluene, propylene, 1-octene, vinyl esters such as vinyl acetate, vinyl pyrrolidinone and/or vinyl pyridine.

The acrylic (co)polymer may be formed from monomers that comprise a compatible crosslinking monomer such as allyl (meth)acrylate, divinyl benzene, ethylene glycol dimethacrylate, ethylene glycol di(meth)acrylate, 1,4-butanediol dimethacrylate, 1,4-butanediol diacrylate, 1,6-hexanediol dimethacrylate and 1,6-hexanediol diacrylate, particularly the compatible acrylic crosslinking monomers.

For the avoidance of doubt, an acrylic in the context of the invention comprises a material formed from monomers that comprise an acrylic monomer (as defined herein). The acrylic may comprise any suitable amount of acrylic monomer(s). For example, the acrylic may comprise at least 10 wt %, such as at least 20 wt %, such as at least 30 wt %, such as at least 40 wt %, such as at least 50 wt %, such as at least 60 wt %, such as at least 70 wt %, such as at least 80 wt %, or even at least 90 wt % of acrylic monomer(s) based on the total solid weight of the monomers from which the acrylic is formed. The acrylic may comprise up to 100 wt % of acrylic monomer(s) based on the total solid weight of the monomers from which the acrylic is formed.

The acrylic may comprise from 10 to 100 wt % of acrylic monomer(s) based on the total solid weight of the monomers from which the acrylic is formed.

For example, the acrylic may comprise up to 90 wt % of additional ethylenically unsaturated monomer(s) based on the total solid weight of the monomers from which the acrylic is formed. The acrylic may comprise up to 80 wt %, such as up to 70 wt %, such as up to 60 wt %, such as up to 50 wt %, such as up to 40 wt %, such as up to 30 wt %, such as up to 20 wt %, or even up to 10 wt % of additional ethylenically unsaturated monomer(s) based on the total solid weight of the monomers from which the acrylic is formed. The acrylic may comprise no, i.e. 0 wt %, additional ethylenically unsaturated monomers based on the total solid weight of the monomers from which the acrylic is formed.

The acrylic feathering reducing agent may be substantially free, may be essentially free or may be completely free of monomers comprising an epoxy group. By substantially free in relation to monomers comprising an epoxy group, is meant that the acrylic is formed from monomers which comprise less than 5 wt % of monomers comprising an epoxy group based on the total weight of the monomers from which the acrylic is formed. By essentially free in relation to monomers comprising an epoxy group, is meant that the acrylic is formed from monomers which comprise less than 1 wt % of monomers comprising an epoxy group based on the total weight of the monomers from which the acrylic is formed. By completely free in relation to monomers comprising an epoxy group, is meant that the acrylic is formed from monomers which comprise less than 0.01 wt % of monomers comprising an epoxy group based on the total weight of the monomers from which the acrylic is formed. The acrylic may be formed from monomers which comprise no, i.e. 0 wt %, monomers comprising an epoxy group based on the total weight of the monomers from which the acrylic is formed.

The acrylic feathering reducing agent may be completely free of monomers comprising an epoxy group.

The acrylic feathering reducing agent may be substantially free, may be essentially free or may be completely free of glycidyl methacrylate. By substantially free in relation to glycidyl methacrylate, is meant that the acrylic is formed from monomers which comprise less than 5 wt % glycidyl methacrylate based on the total weight of the monomers from which the acrylic is formed. By essentially free in relation to glycidyl methacrylate, is meant that the acrylic is formed from monomers which comprise less than 1 wt % glycidyl methacrylate based on the total weight of the monomers from which the acrylic is formed. By completely free in relation to glycidyl methacrylate, is meant that the acrylic is formed from monomers which comprise less than 0.01 wt % glycidyl methacrylate based on the total weight of the monomers from which the acrylic is formed. The acrylic may be formed from monomers which comprise no, i.e. 0 wt %, glycidyl methacrylate based on the total weight of the monomers from which the acrylic is formed.

The acrylic feathering reducing agent may be completely free of glycidyl methacrylate.

The acrylic feathering reducing agent may be substantially free, may be essentially free or may be completely free of styrene. By substantially free in relation to styrene, is meant that the acrylic is formed from monomers which comprise less than 5 wt % of styrene based on the total weight of the monomers from which the acrylic is formed. By essentially free in relation to styrene, is meant that the acrylic is formed from monomers which comprise less than 1 wt % of styrene based on the total weight of the monomers from which the acrylic is formed. By completely free in relation to styrene, is meant that the acrylic is formed from monomers which comprise less than 0.01 wt % of styrene based on the total weight of the monomers from which the acrylic is formed. The acrylic may be formed from monomers which comprise no, i.e. 0 wt %, styrene based on the total weight of the monomers from which the acrylic is formed.

The acrylic feathering reducing agent may be completely free of styrene.

The acrylic feathering reducing agent may be formed from any suitable method. The acrylic may be formed by solution polymerisation or emulsion polymerisation.

The acrylic feathering reducing agent may be formed by solution polymerisation. Suitable solution polymerisation methods will be well known to a person skilled in the art. The solution polymerisation method may comprise a plurality of components, which may be referred to as a solution polymerisation reaction mixture.

The solution polymerisation reaction mixture may comprise a solution polymerisation monomer component. The solution polymerisation monomer component may comprise acrylic monomer(s) as described above. The solution polymerisation monomer component may optionally comprise additional ethylenically unsaturated monomers as described above.

The solution polymerisation reaction mixture may further comprise an initiator. The initiator may be a free radical initiator. Suitable initiators include, but are not limited to, tertiary butyl perbenzoate; tert butyl peroxy 3,5,5 trimethylhexanoate; tertiary butyl peroxy 2-ethyl hexanoate; di tertiary butyl peroxide; tertiary butyl peracetate; tertiary butyl peroctoate; azo type initiators such as, for example, 2,2′-azobis(isobutyronitrile), 2,2′-Azobis(2-methylbutyronitrile), 2,2′-Azobis(2.4-dimethyl valeronitrile) and 2,2′-Azobis(4-methoxy-2.4-dimethyl valeronitrile); persulphate initiators such as, for example, ammonium persulphate, sodium persulphate or potassium persulphate; and combinations thereof. The initiator may be soluble in the solution polymerisation reaction mixture. The initiator may be soluble in the monomer mixture.

The initiator may comprise tertiary butyl peroctoate, tertiary butyl perbenzoate or combinations thereof.

The solution polymerisation reaction mixture may comprise a solvent or mixture of solvents. Suitable solvents will be well known to a person skilled in the art. Examples of suitable solvents include, but are not limited to, alcohols such as, for example, n-butanol, pentanol or hexanol; glycols such as, for example, butyl glycol; glycol ethers such as, for example, 2-butoxy ethanol, 1-methoxy propan-2-ol or dipropylene glycol mono methyl ether; and combinations thereof. The solvent may comprise a mixture of solvents. It will be appreciated by a person skilled in the art that the solvent or mixture of solvents is typically chosen such that the monomer mixture is substantially soluble in said solvent or mixture of solvents.

The solution polymerisation monomer component is caused to undergo polymerisation in the solvent or mixture of solvents. The solution polymerisation of the solution polymerisation monomer component is typically carried out as a free radical initiated solution polymerisation in a solvent or mixture of solvents.

Solution polymerisation is typically carried out in a suitable reaction vessel. The solution polymerisation monomer component, initiator and/or solvent or mixture of solvents may be added to the reaction vessel in any suitable order. For example, the solvent or mixture of solvents may be added to the reaction vessel before the solution polymerisation monomer component and/or initiator are added to the reaction vessel. The solution polymerisation monomer component and initiator may be added to the reaction vessel at the same time. The solution polymerisation monomer component and/or initiator may be added to the reaction vessel over any suitable period of time.

Solution polymerisation may be carried out at any suitable temperature. Solution polymerisation may be carried out at an elevated temperature. Solution polymerisation may be carried out at a temperature from 80° C. to 200° C., such as from 100 to 180° C., such as from 120 to 160° C., such as from 130 to 150° C. or even from 135 to 140° C. Solution polymerisation may be carried out at reflux.

The acrylic feathering reducing agent may be formed by emulsion polymerisation. Suitable emulsion polymerisation methods will be well known to a person skilled in the art. The emulsion polymerisation method may comprise a plurality of components, which may be referred to as an emulsion polymerisation reaction mixture.

The emulsion polymerisation reaction mixture may comprise an emulsion polymerisation monomer component. The emulsion polymerisation monomer component may comprise acrylic monomer(s) as described above. The emulsion polymerisation monomer component may optionally comprise additional ethylenically unsaturated monomers as described above.

The emulsion polymerisation reaction mixture may further comprise an initiator. Suitable initiators are as described above in relation to solution polymerisation.

The emulsion polymerisation reaction mixture may comprise water.

The monomer component of the emulsion polymerisation reaction mixture is caused to undergo polymerisation in the water. The polymerisation of the monomer component of the emulsion polymerisation reaction mixture is typically carried out as a free radical initiated emulsion polymerisation in water. The monomer component of the emulsion polymerisation reaction mixture may form an oil phase in the water.

The emulsion polymerisation reaction mixture may comprise a buffer. Suitable buffers will be well known to a person skilled in the art. The buffer may be operable to act as a hydrogen ion acceptor. Examples of suitable buffers include, but are not limited to, sodium bicarbonate.

The emulsion polymerisation reaction mixture may comprise a surfactant. The surfactant may be an anionic, cationic or non-ionic type stabilizer. Suitable examples of anionic surfactants include, but are not limited to, alkyl sulphates such as, for example, sodium dodecyl sulphate or sodium polyoxy ethylene alkyl ether sulphate; aryl sulphonates such as, for example, sodium dodecylbenzene sulphonate; sulphosuccinates such as, for example, sodium diisobutyl sulpho succinate, sodium dioctyl sulpho succinate and sodium di cyclohexyl sulpho succinate; and combinations thereof. Suitable examples of nonionic emulsifiers include, but are not limited to, fatty alcohol ethoxylates such as, for example polyethylene glycol mono lauryl ether; fatty acid ethoxylates such as, for example, polyethylene glycol mono stearate or polyethylene glycol mono laurate; polyether block polymers such as, for example, polyethylene glycol/polypropylene glycol block polymers also known as pluronics, typical commercial products of this type include Tergitol XJ, XH or XD commercially available from Dow Chemical; and combinations thereof. Suitable examples of cationic emulsifiers include, but are not limited to, amine salts such as, for example, cetyl trimethyl ammonium chloride or benzyl dodecyl dimethyl ammonium bromide; and combinations thereof. It will be appreciated by a person skilled in the art that mixtures of anionic and cationic emulsifiers would typically not be desirable.

The surfactant may be polymeric. The surfactant may be polymerisable with the emulsion polymerised acrylic. For example, the surfactant may be polymerisable with the monomers that form the emulsion polymerised acrylic.

However, the emulsion polymerisation reaction mixture may be substantially free, may be essentially free or may be completely free of surfactant. By substantially free in relation to surfactants, is meant that the emulsion polymerisation reaction mixture comprises less than 5 wt % of surfactant based on the total weight of the emulsion polymerisation reaction mixture. By essentially free in relation to surfactants, is meant that the emulsion polymerisation reaction mixture comprises less than 1 wt % of surfactant based on the total weight of the emulsion polymerisation reaction mixture. By completely free in relation to surfactants, is meant that the emulsion polymerisation reaction mixture comprises less than 0.01 wt % of surfactant based on the total weight of the emulsion polymerisation reaction mixture. The emulsion polymerisation reaction mixture may comprise no, i.e. 0 wt %, surfactant.

Emulsion polymerisation is typically carried out in a suitable reaction vessel. The emulsion polymerisation monomer component, initiator and/or water of the emulsion polymerisation reaction mixture may be added to the reaction vessel in any suitable order. For example, the water may be added to the reaction vessel before the emulsion polymerisation monomer component and/or initiator are added to the reaction vessel. The initiator may be added to the reaction vessel before the emulsion polymerisation monomer component. The emulsion polymerisation monomer component and/or initiator may be added to the reaction vessel over any suitable period of time.

Emulsion polymerisation may be carried out at any suitable temperature. Emulsion polymerisation may be carried out at a temperature from 20° C. to 150° C., such as from 40 to 120° C., such as from 50 to 100° C., such as from 60 to 95° C., such as from 70 to 90° C., or even at 80° C. The temperature is typically held constant throughout the emulsion polymerisation process.

The emulsion polymerised acrylic may be in a core/shell arrangement.

The shell may be formed from a plurality of components, which may be referred to as a shell mixture. The shell mixture may comprise acrylic monomer(s) as described above. The emulsion polymerisation reaction mixture may optionally comprise additional ethylenically unsaturated monomers as described above.

The shell mixture may further comprise initiator(s). Suitable initiators are as described above in relation to solution polymerisation.

The shell mixture is typically caused to undergo polymerisation to form a shell polymer. The polymerisation of the shell mixture is typically carried out as a free radical initiated solution polymerisation in a solvent or mixture of solvents. The solvents which may be used in this process include, but are not limited to, alcohols such as n-butanol, pentanol or hexanol; or glycol ethers such as 2-butoxy ethanol, 1-methoxy propan-2-ol or dipropylene glycol mono methyl ether. Polymerisation may be carried out at an elevated temperature. The polymerisation may be carried out in the range 80° C. to 150° C. The polymerisation can be effectively carried out by adding the shell mixture, over a set time period, to the solvent mixture. The shell mixture may be caused to undergo polymerisation to form a shell polymer prior to contact with components of the core mixture.

Where the shell mixture comprises α,β-ethylenically unsaturated carboxylic acid, the shell polymer will have pendant carboxylic acid functional groups. This may be referred to a carboxylic acid functional shell polymer.

The carboxylic acid functional shell polymer may be contacted with a base to form a water dispersible salt. The carboxylic acid functionality in the carboxylic acid functional shell polymer may be at least partly neutralised with the base. Typically at least 10% of the available carboxylic acid groups are neutralised. Substantially all of the available carboxylic acid groups may be neutralised by the base. The base used for this neutralisation may comprise an amine functional material, or a mixture of amine functional materials. Examples of suitable amine functional materials include ammonia, triethylamine, diethylamine, trimethylamine and morphline or hydroxy amine materials such as ethanol amine, N-methyl ethanol amine and N,N di methyl ethanolamine.

The shell polymer may be dispersed in aqueous medium. In this manner, an aqueous dispersion or solution of the shell polymer may be formed.

The shell mixture may be caused to undergo polymerisation to form a shell polymer by emulsion polymerisation in an aqueous medium, thereby forming an aqueous dispersion or solution of the shell polymer.

The core may be formed from plurality of components, which may be referred to as a core mixture. The core mixture may comprise acrylic monomer(s) as described above. The emulsion polymerisation reaction mixture may optionally comprise additional ethylenically unsaturated monomers as described above.

The polymer formed from the shell mixture, such as an aqueous dispersion thereof, may serve as a dispersant for a subsequent polymerisation, which may be a polymerisation of an α,β-ethylenically unsaturated monomer mixture, such as the core mixture.

The core mixture may further comprise initiator(s). Suitable initiators are as described above in relation to the solution polymerised acrylic.

The core mixture may be caused to undergo polymerisation at a temperature in the range from 30° C. to 99° C., such as in the range from 50° C. to 95° C., such as in the range from 80° C. to 90° C. Polymerisation of the core mixture may occur in the presence of the polymer formed by polymerisation of the shell mixture to thereby form a core/shell polymer, typically by emulsion polymerisation. A typical polymerisation may be carried out by adding the core mixture, at a controlled rate over a period of time, to an aqueous dispersion of shell polymer. During the polymerisation the mixture may be mixed, such as by stirring and the temperature may be held generally constant.

Other methods to polymerise the core mixture include, but are not limited to, mixing all or part of the core ethylenically unsaturated substances with the aqueous dispersion of shell polymer and then adding the remaining core components, including initiator, to the resulting mixture over a set period of time. Suitable temperatures for this type of process are typically in the range 50° C. to 95° C.

For the core/shell composition the ratio of the core mixture (monomers and initiator) to shell mixture (monomers and initiator) may be from 20:80 to 90:10 by weight, such as from 60:40 to 80:20 by weight, or even from 70:30 to 75:25 by weight.

The acrylic feathering reducing agent may have a Mn of at least 500 Da, such as at least 1,000 Da, such as at least 1,500 Da, such as at least 2,000 Da, or even at least 2,500 Da. The acrylic may have a Mn of up to 250,000 Da, such as up to 200,000 Da, such as up to 150,000 Da, such as up to 100,000 Da, such as up to 50,000 Da, such as up to 25,000 Da, or even up to 20,000 Da. The acrylic may have a Mn of from 500 to 250,000 Daltons (Da=g/mole), such as from 1,000 to 200,000 Da, such as from 1,000 to 100,000 Da, such as from 1,500 to 50,000 Da, such as from 2,000 to 25,000 Da, or even from 2,500 to 20,000 Da.

The acrylic feathering reducing agent may have a Mw of at least 500 Da, such as at least 1,000 Da, such as at least 1,500 Da, such as at least 2,000 Da, such as at least 2,500 Da, such as at least 5,000 Da, such as at least 6,000 Da, or even at least 7,000 Da. The acrylic may have a Mw of up to 500,000 Da, such as up to 250,000 Da, such as up to 200,000 Da, such as up to 150,000 Da, such as up to 100,000 Da, such as up to 75,000 Da, or even up to 50,000 Da. The acrylic may have a Mw of from 500 to 500,000 Daltons (Da=g/mole), such as from 1,000 to 250,000 Da, such as from 2,000 to 200,000 Da, such as from 2,500 to 150,000 Da, such as from 5,000 to 100,000 Da, such as from 6,000 to 75,000 Da, or even from 7,000 to 50,000 Da.

The acrylic feathering reducing agent may have a Tg of at least −50° C., such as at least −25° C., such as at least 0° C., such as at least 5° C., such as at least 10° C., or even at least 15° C. The acrylic may have a Tg of up to 250° C., such as up to 200° C., such as up to 150° C., such as up to 125° C., such as up to 100° C., or even up to 75° C. The acrylic may have a Tg from −50 to 250° C., such as from −25 to 200° C., such as from 0 to 150° C., such as from 5 to 125° C., such as from 10 to 100° C., or even from 15 to 80° C.

The acrylic (co)polymer may be formed from monomers that comprise a glycidyl-functional acrylate monomer. The acrylic (co)polymer may be formed from monomers that comprise a glycidyl-functional acrylate monomer and a hydroxyl functional monomer.

The acrylic (co)polymer may be formed from monomers that comprise methyl methacrylate, butyl methacrylate, butyl acrylate, 2-ethylhexyl acrylate, isobornyl methacrylate, hydroxyethyl methacrylate, 4-hydroxybutyl acrylate, and/or glycidyl methacrylate (GMA).

The coating composition may comprise an acrylic feathering reducing agent (i) formed from monomers that comprise a glycidyl-functional acrylate with methyl methacrylate, butyl methacrylate, butyl acrylate, and/or hydroxyethyl methacrylate.

The coating composition may comprise an acrylic feathering reducing agent (i) formed from monomers that comprise a glycidyl-functional acrylate with butyl methacrylate, such as isobutyl methacrylate; ethylhexyl acrylate; and/or 4-hydroxybutyl acrylate.

The acrylic feathering reducing agent (i) may comprise hydroxyl and epoxide groups.

The acrylic feathering reducing agent (i), such as a hydroxyl and epoxide group-containing acrylic feathering reducing agent (i), may be formed from monomers that comprise ≥10 wt % of hydroxyl functional monomer by total weight of monomers, such as ≥15 wt % or ≥20 wt %. The acrylic feathering reducing agent (i) may be formed from monomers that comprise ≤80% of hydroxyl functional monomer by total weight of monomers, such as ≤60 wt % or ≥40 wt %. The acrylic feathering reducing agent (i) may be formed of from 10 to 80% of hydroxyl functional monomer by total weight of monomers, such as from 15 to 60 wt % or from 20 to 40 wt %.

The acrylic feathering reducing agent (i), such as a hydroxyl and epoxide group-containing acrylic feathering reducing agent (i), may be formed from monomers that comprise ≥25% glycidyl-functional monomer, such as glycidyl methacrylate, by total weight of monomers, such as ≥40 wt % or ≥50 wt %. The acrylic feathering reducing agent (i) may be formed from monomers that comprise ≤90% of glycidyl-functional monomer by total weight of monomers, such as ≤80 wt % or ≥70 wt %. The acrylic feathering reducing agent (i) may be formed of from 25 to 90% of glycidyl-functional monomer by total weight of monomers, such as from 40 to 80 wt % or from 50 to 70 wt %.

The composition may comprise a phosphatized epoxy acrylic feathering reducing agent (i). As used herein in relation to a phosphatized epoxy acrylic feathering reducing agent (i), the term “phosphatized epoxy” refers to compound comprising the reaction product of a reaction mixture comprising an epoxy functional acrylic and a source of phosphoric acid, a source of phosphonic acid, or combinations thereof.

The epoxy functional acrylic may be as defined above. The epoxy functional acrylic may have an epoxy equivalent weight of ≥1,000, such as ≥2,000 or ≥2,500.

As reported herein, the epoxy equivalent weight is the mass in grams of sample which contains one mole of unreacted epoxide functionality. A sample of phosphatized epoxy (5.0 g) was weighed out accurately into 120 ml beaker and add 1.5 g of tetraethylammonium bromide. A magnetic stir bar was placed in the beaker and 40 mL methylene chloride and 20 mL acetic acid added. The beaker was covered securely and stirred until the sample was completely dissolved. The sample solution was placed into position for titration and titrated potentiametricaly with 0.1N perchloric acid titrant. A blank solution containing all the above reagents except the sample was also run.

The epoxide content of the sample is equal to:

$$Epoxy Eq Wt = \frac{weight of sample ( g ) \times 1000}{( ( T - R ) \times N )}$$

Wherein T is the titre of percholoric acid solution of sample in mL
R is titre used for the blank in mL, N=normality of the perchloric acid titrant and 1000=conversion factor for grams to milligrams.

All values of EEW for phosphatized epoxy resins were measured using above method.

The epoxy functional acrylic may be formed from monomers that comprise a glycidyl-functional acrylate monomer and a hydroxyl functional monomer.

The epoxy functional acrylic may be formed from monomers that comprise ≥20% of hydroxyl functional monomer by total weight of monomers, such as ≥30 wt % or ≥35 wt %. The epoxy functional acrylic may be formed from monomers that comprise ≥2% glycidyl-functional acrylate monomer by total weight of monomers, such as ≥4 wt % or ≥6 wt %. The epoxy functional acrylic may be formed from monomers that comprise ≤30% glycidyl-functional acrylate monomer by total weight of monomers, such as ≥20 wt % or ≥10 wt %.

The epoxy functional acrylic may be formed from monomers that comprise a glycidyl-functional acrylate monomer, a hydroxyl functional monomer and a cyclic-group-containing monomer, such as an aromatic group-containing monomer.

The epoxy functional acrylic may be formed from monomers that comprise ≥20% of cyclic-group-containing monomer by total weight of monomers, such as ≥30 wt % or ≥35 wt %.

The epoxy functional acrylic may be formed from monomers that comprise a glycidyl-functional acrylate with styrene and/or hydroxyethyl methacrylate.

The source of phosphoric acid may comprise phosphoric acid, such as, orthophosphoric acid, for example, a 100 percent orthophosphoric acid or a phosphoric acid aqueous solution. The phosphoric acid aqueous solution may comprise 70% to 90% by weight of phosphoric acid in water, such as 85% by weight phosphoric acid in water. Other forms of phosphoric acid such as superphosphoric acid, diphosphoric acid and triphosphoric acid may be used as the source of phosphoric acid. Also, the polymeric or partial anhydrides of phosphoric acids may be used as the source of phosphoric acid. The source of phosphonic acid may comprise organophosphonic acid. The organophosphonic acid may comprise 3-amino propyl phosphonic acid, 4-methoxyphenyl phosphonic acid, benzylphosphonic acid, butylphosphonic acid, carboxyethylphosphonic acid, diphenylphosphinic acid, dodecylphosphonic acid, ethylidenediphosphonic acid, heptadecylphosphonic acid, methylbenzylphosphinic acid, naphthylmethylphosphinic acid, octadecylphosphonic acid, octylphosphonic acid, pentylphosphonic acid, methylphenylphosphinic acid, phenylphosphonic acid, styrene phosphonic acid, dodecyl bis-1, 12-phosphonic acid, and/or poly(ethylene glycol) phosphonic acid.

The reactants may comprise ≥80% of epoxy functional acrylic by combined weight of the source of phosphoric acid and epoxy functional acrylic, such as ≥90 wt % or ≥95 wt %.

The reactants may comprise ≥0.5% of a source of phosphoric acid and/or a source of phosphonic acid by combined weight of the source of phosphoric acid and polyepoxide, such as ≥1 wt % or ≥1.5 wt %. The reactants may comprise ≤15% of a source of phosphoric acid and/or a source of phosphonic acid by combined weight of the source of phosphoric acid and polyepoxide, such as ≤10 wt % or ≤5 wt %.

By “acid-functional” it is meant that the acid-functional acrylic feathering reducing agent comprises pendant acid group(s), such as pendant carboxylic acid groups. The pendant acid groups may be end groups or may be on the backbone of the acid-functional acrylic. The acid-functional acrylic feathering reducing agent may comprise a carboxyl group.

The acid functional acrylic feathering reducing agent (i) may be formed of monomers comprising ≥10% acid-functional monomer by total weight of monomers, such as ≥20 wt % or ≥25 wt %.

The acid-functional monomer may comprise an (alk)acrylic acid, such as a (C₁ to C₆ alk)acrylic acid. The acid-functional monomer may comprise an alkacrylic acid and acrylic acid, such as methacrylic acid and acrylic acid.

The acid functional acrylic feathering reducing agent (i) may be formed of monomers comprising ≥2% alkacrylic acid monomer and ≥10% acrylic acid monomer by total weight of monomers, such as ≥5 wt % alkacrylic acid monomer and ≥15 wt % acrylic acid monomer, or ≥7 wt % alkacrylic acid monomer and ≥20% acrylic acid monomer.

The acid-functional acrylic feathering reducing agent may have an acid number of at least 10 mg KOH/g, such as at least 25 mg KOH/g, such as at least 50 mg KOH/g, such as at least 75 mg KOH/g, such as at least 100 mg KOH/g, such as at least 125 mg KOH/g, such as at least 150 mg KOH/g, such as at least 175 mg KOH/g, such as at least 200 mg KOH/g. The acid-functional acrylic feathering reducing agent may have an acid number of up to 500 mg KOH/g, such as up to 475 mg KOH/g, such as up to 450 mg KOH/g, such as up 425 mg KOH/g, such as up to 400 mg KOH/g, such as up to 375 mg KOH/g, such as up to 350 mg KOH/g, such as up to 325 mg KOH/g, such as up to 300 mg KOH/g, or even up to 250 mg KOH/g. The acid-functional acrylic feathering reducing agent may have an acid number of from 10 to 500 mg KOH/g, such as from 25 to 475 mg KOH/g, such as from 50 to 450 mg KOH/g, such as from 75 to 425 mg KOH/g, such as from 100 to 400 mg KOH/g, such as from 125 to 375 mg KOH/g, such as from 150 to 350 mg KOH/g, such as from 175 to 325 mg KOH/g, such as from 200 to 300 mg KOH/g.

The coating composition may comprise acrylic feathering reducing agent (i), in an amount of ≥0.1% by solid weight of the coating composition, such as ≥0.5 wt %, or ≥1 wt %. The coating composition may comprise acrylic feathering reducing agent (i) in an amount of ≤40% by solid weight of the coating composition, such as ≤20 wt %, or ≤15 wt %. The coating composition may comprise acrylic feathering reducing agent (i) in an amount of from 0.1 to 40% by solid weight of the coating composition, such as from 0.5 to 20 wt %, or from 1 to 15 wt %.

The coating composition may comprise an epoxide-functional acrylic feathering reducing agent (i), in an amount of ≥0.1% by solid weight of the coating composition, such as 20.5 wt %, or 21 wt %. The coating composition may comprise an epoxide-functional acrylic feathering reducing agent (i) in an amount of ≤20% by solid weight of the coating composition, such as ≤15 wt %, or ≤10 wt %, or ≤7 wt or ≤5 wt. The coating composition may comprise an epoxide-functional acrylic feathering reducing agent (i) in an amount of from 0.1 to 20% by solid weight of the coating composition, such as from 0.5 to 15 wt %, or from 0.5 to 10 wt % or from 1 to 7 wt % or from 1 to 5 wt %.

The coating composition may comprise a phosphatized epoxy acrylic feathering reducing agent and/or an acid-functional acrylic feathering reducing agent (i) in an amount of ≥1% based on the total solid weight of the coating composition, such as ≥4 wt %, such as ≥6 wt %. The coating composition may comprise a phosphatized epoxy acrylic feathering reducing agent and/or an acid-functional acrylic feathering reducing agent (i) in an amount of ≤40% by solid weight of the coating composition, such as ≤20 wt %, or ≤15 wt %. The coating composition may comprise a phosphatized epoxy acrylic feathering reducing agent and/or an acid-functional acrylic feathering reducing agent (i) in an amount of from 1 to 40% by total solid weight of the coating composition, such as from 4 to 20 wt %, or from 5 to 15 wt %.

The hydroxyl functional polyester feathering reducing agent (ii) may comprise a polyester obtainable by polymerizing a polyacid component with a polyol component, or by ring opening polymerization, such as ring opening polymerization of a lactone component and/or an epoxy component.

Suitable examples of polyacids include, but are not limited to the following: maleic acid; fumaric acid; itaconic acid; adipic acid; azelaic acid; succinic acid; sebacic acid; glutaric acid; decanoic diacid; dodecanoic diacid; phthalic acid; isophthalic acid; 5-tert-butylisophthalic acid; tetrachlorophthalic acid; tetrahydrophthalic acid; trimellitic acid; naphthalene dicarboxylic acid; naphthalene tetracarboxylic acid; terephthalic acid; hexahydrophthalic acid; methylhexahydrophthalic acid; dimethyl terephthalate; cyclohexane dicarboxylic acid; chlorendic anhydride; 1,3-cyclohexane dicarboxylic acid; 1,4-cyclohexane dicarboxylic acid; tricyclodecane polycarboxylic acid; endomethylene tetrahydrophthalic acid; endoethylene hexahydrophthalic acid; cyclohexanetetra carboxylic acid; cyclobutane tetracarboxylic; a monomer having an aliphatic group containing at least 15 carbon atoms; esters and anhydrides of all the aforementioned acids and combinations thereof.

Suitable examples of diacids include, but are not limited to the following: phthalic acid; isophthalic acid; terephthalic acid; 1,4 cyclohexane dicarboxylic acid; succinic acid; adipic acid; azelaic acid; sebacic acid; fumaric acid; 2,6-naphthalene dicarboxylic acid; orthophthalic acid; phthalic anhydride; tetrahydrophthalic acid; hexahydrophthalic acid; maleic acid; succinic acid; itaconic acid; di-ester materials, such as dimethyl ester derivatives for example dimethyl isophthalate, dimethyl terephthalate, dimethyl 1,4-cyclohexane dicarboxylate, dimethyl 2,6-naphthalene di carboxylate, dimethyl fumarate, dimethyl orthophthalate, dimethylsuccinate, dimethyl glutarate, dimethyl adipate; a monomer having an aliphatic group containing at least 15 carbon atoms; esters and anhydrides of all the aforementioned acids; and mixtures thereof.

The polyacid component may comprise: terephthalic acid (TPA), dimethyl terephthalate, isophthalic acid (IPA), dimethyl isophthalic acid, 1,4 cyclohexane dicarboxylic acid, hexahydrophthalic anhydride, 2,6-naphthalene dicarboxylic acid, phthalic anhydride, maleic anhydride, fumaric anhydride; and/or a monomer having an aliphatic group containing at least 15 carbon atoms.

The polyacid component may comprise: isophthalic acid, dimethyl terephthalate, hexahydrophthalic anhydride, cyclohexane 1,4-dicarboxylic acid and/or a monomer having an aliphatic group containing at least 15 carbon atoms.

Suitable examples of polyols include, but are not limited to the following: alkylene glycols, such as ethylene glycol; propylene glycol; diethylene glycol; dipropylene glycol; triethylene glycol; tripropylene glycol; hexylene glycol; polyethylene glycol; polypropylene glycol and neopentyl glycol; hydrogenated bisphenol A; cyclohexanediol; propanediols including 1,2-propanediol; 1,3-propanediol; butyl ethyl propanediol; 2-methyl-1,3-propanediol; and 2-ethyl-2-butyl-1,3-propanediol; butanediols including 1,4-butanediol; 1,3-butanediol; and 2-ethyl-1,4-butanediol; pentanediols including trimethyl pentanediol and 2-methylpentanediol; cyclohexanedimethanol; hexanediols including 1,6-hexanediol; 2,2,4,4-tetraalkylcyclobutane-1,3-diol (TACD), such as 2,2,4,4-tetramethylcyclobutane-1,3-diol (TMCD), 2,2,4-trimethyl-1,3-pentanediol (TMPD), caprolactonediol (for example, the reaction product of a reaction mixture comprising epsilon-capro lactone and ethylene glycol); hydroxyalkylated bisphenols; polyether glycols, for example, poly(oxytetramethylene) glycol; trimethylol propane; pentaerythritol; di-pentaerythritol; trimethylol ethane; trimethylol butane; dimethylol cyclohexane; bio-derived polyols such as glycerol, sorbitol and isosorbide; a monomer having an aliphatic group containing at least 15 carbon atoms; and the like or combinations thereof.

The diols may be selected from: ethylene glycol; 1,2-propane diol; 1,3-propane diol; 1,2-butandiol; 1,3-butandiol; 1,4-butandiol; but-2-ene 1,4-diol; 2,3-butane diol; 2-methyl 1,3-propane diol; 2,2′-dimethyl 1,3-propanediol (neopentyl glycol); 1,5 pentane diol; 3-methyl 1,5-pentanediol; 2,4-diethyl 1,5-pentane diol; 1,6-hexane diol; 2-ethyl 1,3-hexane diol; 2,2,4,4-tetraalkylcyclobutane-1,3-diol (TACD), such as 2,2,4,4-tetramethylcyclobutane-1,3-diol (TMCD), 2,2,4-trimethyl-1,3-pentanediol (TMPD), diethylene glycol; triethylene glycol; dipropylene glycol; tripropylene glycol; 1,4 cyclohexane dimethanol; tricyclodecane dimethanol; isosorbide; 1,4-cyclohexane diol; and/or 1, 1′-isopropylidene-bis (4-cyclohexanol); and mixtures thereof.

The polyol component may comprise a polyol having at least three hydroxyl groups, such as trimethylol propane; pentaerythritol; di-pentaerythritol; trimethylol ethane; trimethylol butane; and/or bio-derived polyols such as glycerol and/or sorbitol. The polyol component having at least three hydroxyl groups may comprise a triol or tetrol, such as trimethylol propane; pentaerythritol; trimethylol ethane; trimethylol butane and/or glycerol. The polyol component having at least three hydroxyl groups may comprise a triol, such as trimethylol propane; trimethylol ethane; and/or trimethylol butane, for example trimethylol propane.

The polyol having at least three hydroxyl groups may be present as a proportion of the solid weight of the polyol component in an amount of ≥0.1 wt %, such as ≥0.5 wt % or ≥0.7 wt %, for example ≥0.8 wt % or ≥0.9 wt %, such as ≥1 wt %.

The polyol having at least three hydroxyl groups may be present as a proportion of the solid weight of the polyol component in an amount of ≤10 wt %, such as ≤8 wt % or ≤6 wt %, for example ≤5 wt % or ≤4 wt %, such as ≤3 wt % or ≤2 wt %.

The polyol having at least three hydroxyl groups may be present as a proportion of the solid weight of the polyol component in an amount of from 0.1 to 10 wt %, such as from 0.5 to 8 wt % or from 0.7 to 6 wt %, for example from 0.8 to 5 wt % or from 0.9 to 4 wt %, such as from 1 to 3 wt % or from 1 to 2 wt %.

In particular the polyol component may comprise ethylene glycol (EG), 1,2-propylene glycol (PG), 2-methyl propanediol (2-MPD), neopentyl glycol (NPG), 1,4-cyclohexane dimethanol (CHDM), butyl ethyl propane diol (BEPD), trimethylolpropane (TMP) and/or 1,6 hexanediol.

Further details of such a monomer having an aliphatic group containing at least 15 carbon atoms are disclosed in published PCT patent application WO 2018/111854, specifically, paragraphs [016] to [030] inclusive. The entire contents of WO 2018/111854 and specifically paragraphs [016] to [030] inclusive thereof are fully incorporated herein by reference.

The hydroxyl functional polyester feathering reducing agent (ii) may have a gross hydroxyl value (OHV) of ≥65 mg KOH/g, such as ≥70 mg KOH/g, or ≥80 mg KOH/g, or such as ≥90 mg KOH/g or 100 mg KOH/g.

The coating composition may comprise hydroxyl functional polyester feathering reducing agent (ii) in an amount of ≥0.1% by solid weight of the coating composition, such as 21 wt % or ≥2 wt %, or ≥23 wt %. The coating composition may comprise hydroxyl functional polyester feathering reducing agent (ii) in an amount of ≤40% by solid weight of the coating composition, such as ≤20 wt %, or ≤15 wt %, or ≤10 wt. The coating composition may comprise hydroxyl functional polyester feathering reducing agent (ii) in an amount of from 0.1 to 40% by solid weight of the coating composition, such as from 1 to 20 wt %, or from 2 to 15 wt %, or from 3 to 10 wt %.

Feathering reducing agent (iii) may comprise a combination of at least two different types of group selected from amine, amide, imine, nitrile and/or hydroxyl groups. The feathering reducing agent (iii) may comprise an amine group with an amide group, an imine group, a nitrile group and/or a hydroxyl group.

Feathering reducing agent (iii) may comprise at least two amine groups, such as at least two primary and/or secondary amine groups, such as at least two primary amine groups.

Feathering reducing agent (iii) may be a small molecule. When used herein, “small molecule” in relation to the feathering reducing agent (iii) may mean a feathering reducing agent (iii) having a molecular weight of 1,500 Daltons (Da), such as ≤1,200 Da or ≤1,000 Da. Suitable examples of a small molecule feathering reducing agent (iii) include but are not limited to: dicyandiamide (DICY), 2,4,6-tris(dimethylaminomethyl)phenol (TAP), and/or hydroxyalkylamide, and derivates thereof.

Feathering reducing agent (iii) may be a polymer, such as a polyamide. A polyamide feathering reducing agent may comprise an amine-terminated polyamide.

A polyamide feathering reducing agent (iii) may have an amine value of ≥150 mg KOH/gram resin, such as ≥180 mg KOH/gram resin, or ≥200 mg KOH/gram resin, or ≥220 mg KOH/gram resin.

As reported herein, the amine value was determined by titration with 0.1M perchloric acid (HClO₄) in glacial acetic acid solution. A sample of solid polyamide (0.1 g) was weighed accurately into a conical flask and dissolved, using light heating and stirring as appropriate, in 25 ml of acetic acid containing methyl violet indicator. The solution was then cooled to room temperature and titrated with the 0.1M perchloric acid in glacial acetic acid solution. The resulting amine number is expressed in units of mg KOH/g and is calculated using the following equation:

Amine number=titre of HClO₄ solution (ml)×molarity HClO₄ solution (M)×56.1 weight of solid sample (g)

All values for amine number reported herein were measured in this way.

The coating composition may comprise feathering reducing agent (iii) in an amount of ≥0.001% by solid weight of the coating composition, such as ≥0.01 wt % or ≥0.05 wt %. The coating composition may comprise feathering reducing agent (iii) in an amount of ≤5% by solid weight of the coating composition, such as ≤3 wt %, or ≤2 wt %, or ≤1 wt. The coating composition may comprise feathering reducing agent (iii) in an amount of from 0.001 to 5% by solid weight of the coating composition, such as from 0.01 to 3 wt %, or from 0.01 to 2 wt %, or from 0.05 to 1 wt %.

The composition may comprise a phosphatized epoxy feathering reducing agent (iv). As used herein in relation to feathering reducing agent (iv), the term “phosphatized epoxy” refers to compound comprising the reaction product of a reaction mixture comprising a polyepoxide and a source of phosphoric acid, a source of phosphonic acid, or combinations thereof.

The polyepoxide may comprise any compound or mixture of compounds having more than 1.0 epoxy groups per molecule. The polyepoxide may comprise a polyglycidyl ether of a polyol, such as a cyclic polyol in which the bridging group comprises a cyclic moiety, for example a polyphenol or an alicyclic polyol, such as a diglycidyl ether of bisphenol A, bisphenol F or 1,4-cylcohexanedimethanol. The polyol may comprise any compound or mixture of compounds having more than 1.0 hydroxyl groups per molecule. The poly may comprise a diol.

As will be appreciated, such polyepoxides can be produced by etherification of a polyphenol with an epichlorohydrin in the presence of an alkali. Suitable polyphenols that may be used to produce the polyepoxide include, without limitation, I,I-bis(4-hydroxyphenyl)ethane; 2,2-bis(4-hydroxyphenyl)propane; I,I-bis(4-hydroxyphenyl)isobutane; 2,2-bis(4-hydroxytertiarybutylphenyl)propane; bis(2-hydroxynaphthyl)methane; 1,5-dihydroxynaphthalene; I, I-bis(4-hydroxy-3-allylphenyl)ethane; and 4,4-bis(4′-hydroxyphenyl)valeric acid.

The source of phosphoric acid may comprise phosphoric acid, such as, orthophosphoric acid, for example, a 100 percent orthophosphoric acid or a phosphoric acid aqueous solution. The phosphoric acid aqueous solution may comprise 70% to 90% by weight of phosphoric acid in water, such as 85% by weight phosphoric acid in water. Other forms of phosphoric acid such as superphosphoric acid, diphosphoric acid and triphosphoric acid may be used as the source of phosphoric acid. Also, the polymeric or partial anhydrides of phosphoric acids may be used as the source of phosphoric acid. The source of phosphonic acid may comprise organophosphonic acid. The organophosphonic acid may comprise 3-amino propyl phosphonic acid, 4-methoxyphenyl phosphonic acid, benzylphosphonic acid, butylphosphonic acid, carboxyethylphosphonic acid, diphenylphosphinic acid, dodecylphosphonic acid, ethylidenediphosphonic acid, heptadecylphosphonic acid, methylbenzylphosphinic acid, naphthylmethylphosphinic acid, octadecylphosphonic acid, octylphosphonic acid, pentylphosphonic acid, methylphenylphosphinic acid, phenylphosphonic acid, styrene phosphonic acid, dodecyl bis-1, 12-phosphonic acid, and/or poly(ethylene glycol) phosphonic acid.

The reactants may comprise ≥70% of polyepoxide by combined weight of the source of phosphoric acid and polyepoxide, such as ≥80 wt % or ≥82 wt %. The reactants may comprise ≤95% of polyepoxide by combined weight of the source of phosphoric acid and polyepoxide, such as ≤90 wt % or ≤88 wt %. The reactants may comprise from 70 to 95% of polyepoxide by combined weight of the source of phosphoric acid and polyepoxide, such as from 80 to 90 wt % or from 82 to 88 wt %.

The reactants may comprise ≥5% of a source of phosphoric acid and/or a source of phosphonic acid by combined weight of the source of phosphoric acid and polyepoxide, such as ≥10 wt % or ≥12 wt %. The reactants may comprise ≥30% of a source of phosphoric acid and/or a source of phosphonic acid by combined weight of the source of phosphoric acid and polyepoxide, such as ≤20 wt % or ≤18 wt %. The reactants may comprise from 5 to 30% of a source of phosphoric acid and/or a source of phosphonic acid by combined weight of the source of phosphoric acid and polyepoxide, such as from 10 to 20 wt % or from 12 to 18 wt %.

The coating composition may comprise feathering reducing agent (iv) in an amount of ≥0.1% by solid weight of the coating composition, such as ≥0.5 wt % or ≥1 wt %. The coating composition may comprise feathering reducing agent (iv) in an amount of ≥40% by solid weight of the coating composition, such as ≤20 wt %, or ≤15 wt %, or ≤10 wt. The coating composition may comprise feathering reducing agent (iv) in an amount of from 0.1 to 40% by solid weight of the coating composition, such as from 0.5 to 20 wt %, or from 0.5 to 15 wt %, or from 1 to 10 wt %.

The phenolic feathering reducing agent (v) may have an aliphatic hydroxyl equivalent weight on solids of ≥60, such as ≥80 or ≥90. The phenolic feathering reducing agent (v) may have an aliphatic hydroxyl equivalent weight of ≤500, such as ≤300, or ≤200 or ≤160. The phenolic feathering reducing agent (v) may have an aliphatic hydroxyl equivalent weight of from 60 to 500, or 60 to 300, such as from 80 to 200 or from 90 to 160.

As reported herein, the aliphatic hydroxyl equivalent weight was determined by the following equation:

Molecular mass of structure/number of aliphatic hydroxyl functional groups in structure

For a polymer structure, the structure mass and functionality that was used was an average. This can also be derived by making a weighted average of the equivalent weight of the idealised structures according to the normal practices of a person of skill in art.

The phenolic feathering reducing agent (v) may comprise a resin that is a reaction product of a reaction mixture comprising phenol or a derivative thereof with an aldehyde, such as formaldehyde.

The phenolic feathering reducing agent (v) may be substantially non-alkylated/non-etherified.

Non-limiting examples of the phenol or a derivative thereof reactant which may be used to form the phenolic feathering reducing agent (v) are phenol, butyl phenol, xylenol and/or cresol (ortho-, meta-, and/or para-cresol). The phenol or a derivative thereof reactant may comprise phenol and cresol. The phenol or a derivative thereof reactant may comprise ≥80% phenol by combined weight of all phenol or a derivative thereof reactants.

The phenolic feathering reducing agent (v) may be of the resol type. By “resol type” it is meant resins formed in the presence of a basic (alkaline) catalyst and optionally an excess of formaldehyde.

The phenolic feathering reducing agent (v) may be water-miscible.

The coating composition may comprise phenolic feathering reducing agent (v) in an amount of ≥0.1% by solid weight of the coating composition, such as ≥0.3 wt % or ≥0.5 wt %. The coating composition may comprise phenolic feathering reducing agent (v) in an amount of ≤40% by solid weight of the coating composition, such as ≤20 wt %, or ≤15 wt %, or ≤10 wt. The coating composition may comprise phenolic feathering reducing agent (v) in an amount of from 0.1 to 40% by solid weight of the coating composition, such as from 0.3 to 20 wt %, or from 0.5 to 15 wt %, or from 0.5 to 10 wt %.

General preparation of phenolic resins is described in “The Chemistry and Application of Phenolic Resins or Phenoplasts”, Vol V, Part I, edited by Dr Oldring; John Wiley and Sons/Cita Technology Limited, London, 1997.

Advantageously, it has been found that phenolic feathering reducing agent (v) may improve feathering and may also maintain or improve other desirable properties such as hairing, mobility, stability and/or blistering.

A feathering reducing agent comprising an oxazolyl functional group (vi) may have pH of 7 to 11, such as from 7.5 to 10.5 or from 8 to 10.

A feathering reducing agent comprising an oxazolyl functional group (vi) may have an oxazoline value of ≥2 mmol/g, such as ≥3 mmol/g or ≥4 mmol/g. A feathering reducing agent comprising an oxazolyl functional group (vi) may have an oxazoline value of 15 mmol/g, such as 10 mmol/g or ≤8 mmol/g. A feathering reducing agent comprising an oxazolyl functional group (vi) may have an oxazoline value of from 2 to 15 mmol/g, such as from 3 to 10 mmol/g or from 4 to 8 mmol/g.

A feathering reducing agent comprising an oxazolyl functional group (vi) may be a (co)polymer comprising an oxazolyl functional group.

A feathering reducing agent comprising an oxazolyl functional group (vi) may have a Tg of ≥30° C., such as ≥40° C. or ≥45° C. A feathering reducing agent comprising an oxazolyl functional group (vi) may have a Tg of ≤120° C., such as ≤100° C. or ≤70° C. A feathering reducing agent comprising an oxazolyl functional group (vi) may have a Tg of from 30 to 120° C., such as from 40 to 100° C. or from 45 to 70° C.

A feathering reducing agent comprising an oxazolyl functional group (vi) may have a Mn of ≥10,000 Da, such as ≥15,000 Da or ≥17,000 Da. A feathering reducing agent comprising an oxazolyl functional group (vi) may have a Mn of ≤100.000 Da, such as ≤50.000 Da or ≤30,000 Da. A feathering reducing agent comprising an oxazolyl functional group (vi) may have a Mn of from 10,000 to 100,000 Da, such as from 15,000 to 50,000 Da or from 17,000 to 30,000 Da.

A feathering reducing agent comprising an oxazolyl functional group (vi) may have a Mw ≥10,000 Da, such as ≥40,000 Da or ≥60,000 Da. A feathering reducing agent comprising an oxazolyl functional group (vi) may have a Mw≤200,000 Da, such as ≤100,000 Da or ≤80,000 Da. A feathering reducing agent comprising an oxazolyl functional group (vi) may have a Mw of from 10,000 to 200,000 Da, such as from 40,000 to 100,000 Da or from 60,000 to 80,000 Da.

The feathering reducing agent comprising an oxazolyl functional group (vi) may be a polyoxazoline. Further details of suitable polyoxazolines comprising an oxazolyl functional group are disclosed in US patent application 2019/0185706, the entire contents of which are fully incorporated herein by reference. In particular reference is made to paragraphs [0026] to [0049] of US patent application 2019/0185706, the contents of which are fully incorporated herein by reference. Further details of suitable polyoxazolines comprising an oxazolyl functional group are also disclosed in patent application WO 2019/116327, the entire contents of which are fully incorporated herein by reference. In particular reference is made to paragraphs [0043] to [0051] of patent application WO 2019/116327, the contents of which are fully incorporated herein by reference. Further details of suitable polyoxazolines comprising an oxazolyl functional group are also disclosed in patent application WO 2019/116328, the entire contents of which are fully incorporated herein by reference. In particular reference is made to paragraphs [0020] to [0023] of patent application WO 2019/116328, the contents of which are fully incorporated herein by reference.

A feathering reducing agent comprising an oxazolyl functional group (vi) may be an acrylic feathering reducing agent comprising an oxazolyl functional group. An acrylic feathering reducing agent comprising an oxazolyl functional group (vi) may be an acrylic as defined above in relation to the acrylic feathering reducing agent (i).

The coating composition may comprise a feathering reducing agent comprising an oxazolyl functional group (vi) in an amount of ≥1% by solid weight of the coating composition, such as ≥2 wt % or ≥3 wt %. The coating composition may comprise a feathering reducing agent comprising an oxazolyl functional group (vi), in an amount of ≤40% by solid weight of the coating composition, such as ≤20 wt %, or ≤15 wt %, or ≤10 wt. The coating composition may comprise a feathering reducing agent comprising an oxazolyl functional group (vi), in an amount of from 1 to 40% by solid weight of the coating composition, such as from 1 to 20 wt %, or from 2 to 15 wt %, or from 3 to 10 wt %.

Examples of suitable feathering reducing agents include DOMACRYL 285 (available from Helios Resins); TEGO LP1600, TEGO DS1300, TEGO LP1611 (available from Evonik Industries); DOMOPOL 5144 (available from Helios resins); Versamid 115 (available from Gabriel); Curaphen 40-804 (available form Bitrez); and Epocros WS500, Epocros WS300 and Epocros WS700 (available from Nippon Shokubai).

The coating composition may comprise an epoxy resin. The coating composition may comprise an epoxy resin when the composition comprises a feathering reducing agent comprising a functional group selected from amine, amide, imine and/or nitrile. The coating composition may comprise a small molecule feathering reducing agent (iii) and an epoxy resin.

The coating composition may comprise a polyester additive. The polyester additive may comprise the reaction product of a reaction mixture comprising (i) a polyacid, (ii) a polyol and (iii) phosphorus acid, such as the reaction product of a reaction mixture comprising a pre-cursor polyester with a phosphorus acid, such as phosphoric acid. The polyester may have an Mn of 2000 to 10,000. The polyester may have a hydroxyl number of 20 to 75. The polyester may have an acid value of 15 to 25.

The polyester additive may comprise a solution of a copolymer with acidic groups having an acid value from 15 up to 100 mgKOH/g. Examples of commercially available suitable acidic polyesters include are BYK-4510 (commercially available from Byk Altana) or PLUSOLIT H-PD (commercially available from Mäder) or BORCHI GEN HMP-F or BORCHI GEN HE (commercially available from OMG Borchers).

The acidic polyester may generally comprise the reaction product of a reaction mixture comprising:
(a) a polyester having an Mn of 2000 to 10,000, a hydroxyl number of 20 to 75, and an acid value of 15 to 25; the polyester being a polycondensate of:
   (i) a polyol component, such as comprising a mixture of diols and triols,
   (ii) a polyacid component, such as comprising an alpha, beta-ethylenically unsaturated polycarboxylic acid, and
(b) a phosphorus acid.

The polyester additive may be added in an amount of from 0.1 to 15 wt % (based on the solids weight of the coating composition), such as from 2 to 12 wt % (based on the solids weight of the coating composition). The polyester additive may be present in an amount of from 4 to 10 wt % (based on the solids weight of the coating composition).

Further suitable examples of polyester additives are given in WO 2012/162301, the contents of which are entirely incorporated herein by reference.

The coating composition may be essentially free or may be completely free of a polyester additive comprising the reaction product of a reaction mixture comprising (i) a polyacid, (ii) a polyol and (iii) phosphorus acid, such as the reaction product of a reaction mixture comprising a pre-cursor polyester with a phosphorus acid. By essentially free in relation to the polyester additive it is meant that the coating composition comprises less than 0.05 wt % of the polyester additive based on the total solid weight of the coating composition. By completely free in relation to the polyester additive, it is meant that the coating composition comprises less than 0.01 wt % of the polyester additive based on the total solid weight of the coating composition. The coating composition may comprise no, i.e. 0 wt %, of the polyester additive by total solids weight of the coating composition.

The coating composition may comprise a crosslinking material. The coating composition may comprise any suitable crosslinking material. Suitable crosslinking materials will be well known to the person skilled in the art.

The crosslinking material may be operable to crosslink the polyester material. The crosslinking material may be a single molecule, a dimer, an oligomer, a (co)polymer or a mixture thereof. The crosslinking material may be a dimer or trimer.

Suitable crosslinking materials include, but are not limited to: phenolic resins (or phenol-formaldehyde resins); aminoplast resins (or triazine-formaldehyde resins); amino resins; epoxy resins; isocyanate resins; beta-hydroxy (alkyl) amide resins; alkylated carbamate resins; polyacids; anhydrides; organometallic acid-functional materials; polyamines; and/or polyamides and combinations thereof.

Suitable examples of phenolic resins are those formed from the reaction of a phenol with an aldehyde or a ketone, such as from the reaction of a phenol with an aldehyde, such as from the reaction of a phenol with formaldehyde or acetaldehyde, or even from the reaction of a phenol with formaldehyde. Non-limiting examples of phenols which may be used to form phenolic resins are phenol, butyl phenol, xylenol and cresol. General preparation of phenolic resins is described in “The Chemistry and Application of Phenolic Resins or Phenoplasts”, Vol V, Part I, edited by Dr Oldring; John Wiley and Sons/Cita Technology Limited, London, 1997. The phenolic resins may be of the resol type. By “resol type” we mean resins formed in the presence of a basic (alkaline) catalyst and optionally an excess of formaldehyde. Suitable examples of commercially available phenolic resins include, but are not limited to those sold under the trade name PHENODUR® commercially available from Allnex, such as PHENODUR EK-827, PHENODUR VPR1785, PHENODUR PR 515, PHENODUR PR516, PHENODUR PR 517, PHENODUR PR 285, PHENODUR PR612 or PHENODUR PH2024; resins sold under the trade name BAKELITE® commercially available from Sumitomo Bakelite co., ltd., such as BAKELITE 6582 LB, BAKELITE 6535, BAKELITE PF9989 or BAKELITE PF6581; SFC 112 commercially available from SI Group; DUREZ® 33356 commercially available from SHHPP; ARALINK® 40-852 commercially available from Bitrez; or combinations thereof.

Suitable examples of isocyanate resins include, but are not limited to the following: isophorone diisocyanate (IPDI), such as those sold under the trade name DESMODUR® commercially available from Cevstro, for example DESMODUR VP-LS 2078/2 or DESMODUR PL 340 or those sold under the trade name VESTANAT® commercially available from Evonik, for example VESTANANT B 1370, VESTANAT B 118 6A or VESTANAT B 1358 A; blocked aliphatic polyisocyanate based on hexamethylene diisocyanate (HDI), such as those sold under the trade name DESMODUR® commercially available from Covestro, for example DESMODUR BL3370 or DESMODUR BL 3175 SN, those sold under the trade name DURANATE® commercially available from Asahi KASEI, for example DURANATE MF-K60X, those sold under the trade name TOLONATE® commercially available from Vencorex Chemicals, for example TOLONATE D2 or those sold under the trade name TRIXENE® commercially available from Baxenden, for example TRIXENE-BI-7984 or TRIXENE 7981; or combinations thereof.

The crosslinking material may contain nitrogen. The crosslinking material may be in the form of an amine or amide material. The crosslinking material may comprise a hydroxyl substituted amine or amide material.

The crosslinking material may comprise a hydroxyalkylamide material, such as a (3-hydroxyalkylamide material.

The crosslinking material may comprise a commercially available β-hydroxyalkylamide crosslinking, such as, for example, PRIMID XL-552 (available from EMS); PRIMID QM-1260 (available from EMS Chemie); and N,N,N′,N′-tetrakis(2-hydroxypropyl)adipamide.

The crosslinking material may be in the form of a urea material. The crosslinking material may comprise a hydroxyl substituted urea material. The crosslinking material may comprise a hydroxy functional alkyl polyurea material.

The hydroxy functional alkyl polyurea material may comprise a material according to formula (I):

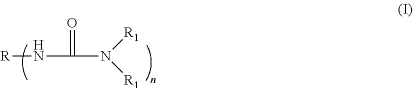

wherein R comprises an isocyanurate moiety, biuret moiety, allophonate moiety, glycoluril moiety, benzoguanamine moiety, polyetheramine moiety, and/or polymeric moiety different from a polyetheramine and having an Mn of 500 or greater; wherein each R1 is independently a hydrogen, alkyl having a carbon, or a hydroxy functional alkyl having 2 or more carbons and at least one R1 is a hydroxy functional alkyl having 2 or more carbons; and n is 2-6.

The hydroxy functional alkyl polyurea material may comprise a material according to formula (II):

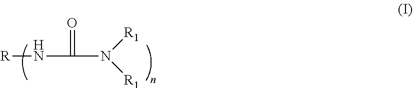

wherein R2 is a substituted or unsubstituted C1 to C36 alkyl group, an aromatic group, an isocyanurate moiety, biuret moiety, allophonate moiety, glycoluril moiety, benzoguanamine moiety, polyetheramine moiety, and/or polymeric moiety different from a polyetheramine and having an Mn of 500 or greater; wherein each R1 is independently a hydrogen, an alkyl having a carbon, or a hydroxy functional alkyl having 2 or more carbons and at least one R1 is a hydroxyl functional alkyl having 2 or more carbons; and n is 2-6.

Further details of suitable hydroxy functional alkyl polyurea materials are disclosed in PCT patent application WO 2017/123955, the entire contents of which are fully incorporated herein by reference.

Suitable examples of aminoplast resins include those which are a reaction product of a reaction mixture comprising a triazine such as melamine or benzoguanamine and formaldehyde. These condensates may be etherified, typically, with methanol, ethanol, butanol or mixtures thereof. For the chemistry, preparation and use of aminoplast resins, see “The Chemistry and Applications of Amino Crosslinking agents or Aminoplast”, Vol. V, Part 11, page 21 ff., edited by Dr. Oldring; John Wiley & Sons/Cita Technology Limited, London, 1998. Suitable examples of commercially available aminoplast resins include, but are not limited to, those sold under the trade name MAPRENAL (registered trade mark), such as MAPRENAL MF980 (commercially available from Ineos); those sold under the trade name CYMEL (registered trade mark), such as CYMEL 303 and CYMEL 1128 (available from Allnex Industries); and combinations thereof.

The crosslinking material may comprise material according to formula (III)

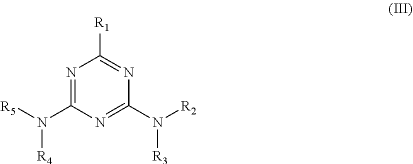

wherein R₁ represents hydrogen, alkyl (such as C₁ to C₂₀ alkyl), aryl (such as C₄ to C₂₄ aryl), aralkyl (such as C₅ to C₂₅ aralkyl), or —NR₆R₇;
R₂ to R₇ each independently represent hydrogen, alkyl (such as C₁ to C₂₀ alkyl), aryl (such as C₄ to C₂₄ aryl), aralkyl (such as C₅ to C₂₅ aralkyl) or —CHR₃OR₉;
wherein R₈ and R₉ each independently represent hydrogen, alkyl (such as C₁ to C₂₀ alkyl), aryl (such as C₄ to C₂₄ aryl), aralkyl (such as C₅ to C₂₅ aralkyl), alkoxyalkyl (such as C₂ to C₄₀
alkoxyalkyl) or an alkaryl (such as C₅ to C₂₅ alkaryl);
wherein at least one of R₂ to R₅, or R₂ to R₇ when present, is —CHR₈OR₉, for example all of R₂ to R₅, or R₂ to R₇ when present, may be —CHR₈OR₉.

In the crosslinking material according to formula (III), R₁ may be C₁ to C₂₀ alkyl, C₄ to C₂₄ aryl, C₅ to C₂₅ aralkyl, or —NR₆R₇; such as C₄ to C₂₄ aryl or C₅ to C₂₅ aralkyl, or C₄ to C₂₄ aryl, such as C₄ to C₁₂ aryl, such as C₆ aryl.

In the crosslinking material according to formula (III), R₁ may be —NR₆R₇.

In the crosslinking material according to formula (III), R₂ to R₇, when present as applicable, may each be independently hydrogen, C₁ to C₂₀ alkyl, C₄ to C₂₄ aryl or —CHR₈OR₉; such as hydrogen, C₁ to C₂₀ alkyl or —CHR₃OR₉, such as hydrogen, C₁ to C₁₀ alkyl or —CHR₃OR₉; such as C₁ to C₅ alkyl or —CHR₃OR₉, such as —CHR₈OR₉.

In the crosslinking material according to formula (III), R₂ to R₇, when present as applicable, may each be independently hydrogen, C₁ to C₂₀ alkyl, C₄ to C₂₄ aryl or —CHR₈OR₉; such as hydrogen, C₁ to C₂₀ alkyl or —CHR₃OR₉, such as hydrogen, C₁ to C₁₀ alkyl or —CHR₃OR₉; such as C₁ to C₅ alkyl or —CHR₈OR₉, such as —CHR₈OR₉, and Ra may be independently be hydrogen, C₁ to C₂₀ alkyl, C₄ to C₂₄ aryl, C₅ to C₂₅ aralkyl, alkoxyalkyl C₂ to C₄₀ alkoxyalkyl or C₅ to C₂₅ alkaryl, such as hydrogen, C₁ to C₂₀ alkyl, such as hydrogen; and R₉ may be hydrogen, C₁ to C₂₀ alkyl, C₄ to C₂₄ aryl, C₅ to C₂₅ aralkyl, alkoxyalkyl C₂ to C₄₀ alkoxyalkyl or C₅ to C₂₅ alkaryl; such as hydrogen, C₁ to C₂₀ alkyl; such as C₁ to C₂₀ alkyl, or C₁ to C₁₀ alkyl, or C₁ to C₅ alkyl, such as C₁ or C₂ alkyl.

The crosslinking material according to formula (III) may be a reaction product of a reaction mixture comprising a triazine such as melamine or benzoguanamine and formaldehyde. These condensates may be etherified, typically, with methanol, ethanol, butanol or mixtures thereof. For the chemistry, preparation and use of aminoplast resins, see “The Chemistry and Applications of Amino Crosslinking agents or Aminoplast”, Vol. V, Part 11, page 21 ff., edited by Dr. Oldring; John Wiley & Sons/Cita Technology Limited, London, 1998.

The crosslinking material according to formula (III) may comprise melamine or derivatives thereof, such as butylated and/or methylated melamine; and/or benzoguanamine or derivatives thereof, such as butylated and/or methylated benzoguanamine. The crosslinking material according to formula (III) may comprise benzoguanamine or derivatives thereof, such as butylated and/or methylated benzoguanamine.

The crosslinking material may comprise those which are the reaction product of a reaction mixture comprising a triazine, such as melamine or benzoguanamine, and formaldehyde.

The crosslinking material may comprise benzoguanamine or a derivative thereof.

The benzoguanamine or derivative thereof may comprise commercially available benzoguanamine or derivative thereof. Suitable examples of commercially available benzoguanamine and its derivatives include, but are not limited to benzoguanamine-formaldehyde based materials such as those sold under the trade name CYMEL (registered trade mark), for example CYMEL 1123 (commercially available from Allnex Industries), those sold under the trade name ITAMIN (registered trade mark), for example ITAMIN BG143 (commercially available from Galstaff Multiresine) or those sold under the trade name MAPRENAL (registered trade mark), for example, MAPRENAL BF892 and MAPRENAL BF 892/68B (commercially available from Ineos); glycoluril based materials, such as those sold under the trade name CYMEL (registered trade mark), for example, CYMEL 1170 and CYMEL 1172 (commercially available from Allnex); and combinations thereof.

The benzoguanamine or derivative thereof may comprise benzoguanamine-formaldehyde based materials sold under the trade name MAPRENAL (registered trade mark).

The benzoguanamine or derivative thereof may comprise MAPRENAL BF892 and/or MAPRENAL BF 892/68B (commercially available from Ineos). Benzoguanamine or derivative thereof may comprise MAPRENAL BF 892/68B (commercially available from Ineos).

The crosslinking material may be present in the coating composition in any suitable amount.

The coating composition may comprise at least 0.5 wt % crosslinking material based on the total solid weight of the coating composition. Such as at least 1 wt %, at least 5 wt %, at least 10 wt %, or at least 15 wt % crosslinking material based on the total solid weight of the coating composition.

The coating composition may comprise up to 70 wt % crosslinking material based on the total solid weight of the coating composition. Such as up to 60 wt %, up to 50 wt %, up to 40 wt %, up to 30 wt %, up to 25 wt %, or up to 20 wt % crosslinking material based on the total solid weight of the coating composition.

The coating composition may comprise from 0.5 to 90 wt %, or 1 to 90 wt %, such as from 1 to 80 wt %, such as from 1 to 70 wt %, such as from 1 to 60 wt %, such as from 1 to 50 wt %, such as from 1 to 40 wt %, such as from 1 to 30 wt %, or even from 1 to 25 wt % crosslinking material based on the total solid weight of the coating composition. The coating composition may comprise from 5 to 90 wt %, such as from 5 to 80 wt %, such as from 5 to 70 wt %, such as from 5 to 60 wt %, such as from 5 to 50 wt %, such as from 5 to 40 wt %, such as from 5 to 30 wt %, or even from 5 to 25 wt % crosslinking material based on the total solid weight of the coating composition. The coating composition may comprise from 10 to 90 wt %, such as from 10 to 80 wt %, such as from 10 to 70 wt %, such as from 10 to 60 wt %, such as from 10 to 50 wt %, such as from 10 to 40 wt %, such as from 10 to 30 wt %, or even from 10 to 25 wt %, or 10 to 20 wt %, crosslinking material based on the total solid weight of the coating composition. The coating composition may comprise from 15 to 90 wt %, such as from 15 to 80 wt %, such as from 15 to 70 wt %, such as from 15 to 60 wt %, such as from 15 to 50 wt %, such as from 15 to 40 wt %, such as from 15 to 30 wt %, or even from 15 to 25 wt % crosslinking material based on the total solid weight of the coating composition.

The coating compositions may further comprise a catalyst. Any catalyst typically used to catalyse crosslinking reactions between polyester materials and crosslinking agents may be used. Suitable catalysts will be well known to the person skilled in the art. The catalyst may be a non-metal or a metal catalyst or a combination thereof. Suitable non-metal catalysts include, but are not limited to the following: phosphoric acid; blocked phosphoric acid; CYCAT® XK 406 N (commercially available from Allnex); sulfuric acid; sulfonic acid; CYCAT 600 (commercially available from Allnex); NACURE® 5076 or NACURE 5925 (commercially available from King industries); acid phosphate catalyst such as NACURE XC 235 (commercially available from King Industries); and combinations thereof. Suitable metal catalysts will be well known to the person skilled in the art. Suitable metal catalysts include, but are not limited to the following: tin containing catalysts, such as monobutyl tin tris (2-ethylhexanoate); zirconium containing catalysts, such as KKAT® 4205 (commercially available from King Industries); titanate based catalysts, such as tetrabutyl titanate TnBT (commercially available from Sigma Aldrich); and combinations thereof.

Suitable examples of catalysts may include, but are not limited to the following: metal compounds such as stannous octoate; stannous chloride; butyl stannoic acid (hydroxy butyl tin oxide); monobutyl tin tris (2-ethylhexanoate); chloro butyl tin dihydroxide; tetra-n-propyl titanate; tetra-n-butyl titanate; zinc acetate; acid compounds such as phosphoric acid; para-toluene sulphonic acid; dodecyl benzene sulphonic acid (DDBSA) such as blocked DDBSA, tetra alkyl zirconium materials, antimony trioxide, germanium dioxide and combinations thereof. The catalyst may comprise dodecyl benzene sulphonic acid (DDBSA), such as blocked DDBSA.

The catalyst, when present, may be used in the coating composition in any suitable amount. The catalyst may be present in the coating composition in an amounts of ≥0.001% by solid weight of the coating composition coating composition, such as ≥0.01%, such as ≥0.025% by solid weight of the coating composition. The catalyst may be present in the coating composition in an amount of ≤1% by solid weight of the coating composition coating composition, such as ≤0.7%, such as ≤0.5% by solid weight of the coating composition. The catalyst may be present in the coating composition in amounts from 0.001 to 1% by solid weight of the coating composition coating composition, such as from 0.01 to 0.7%, such as from 0.025 to 0.5% by solid weight of the coating composition.

The coating compositions may comprise a further resin material. Suitable further resin materials will be well known to a person skilled in the art. Suitable examples of further resin materials include, but are not limited to the following: polyester resins; acrylic resins; polyvinyl chloride (PVC) resins; alkyd resins; polyurethane resins; polysiloxane resins; epoxy resins or combinations thereof.

The coating compositions may comprise other optional materials well known in the art of formulating coatings, such as plasticizers, abrasion-resistant particles, anti-oxidants, hindered amine light stabilizers, UV light absorbers and stabilizers, surfactants, flow control agents, thixotropic agents, fillers, organic co-solvents, reactive diluents, catalysts, grind vehicles, lubricants, waxes and other customary auxiliaries.

Suitable lubricants will be well known to the person skilled in the art. Suitable examples of lubricants include, but are not limited to the following: carnauba wax and polyethylene type lubricants. The lubricant, when present, may be used in the coating composition in amounts of at least 0.01 wt % based on the total solid weight of the coating composition.

Surfactants may optionally be added to the coating composition in order to aid in flow and wetting of the substrate. Suitable surfactants will be well known to the person skilled in the art. The surfactant, when present, is chosen to be compatible with food and/or beverage container applications. Suitable surfactants include, but are not limited to the following: alkyl sulphates (e.g., sodium lauryl sulphate); ether sulphates; phosphate esters; sulphonates; and their various alkali, ammonium, amine salts; aliphatic alcohol ethoxylates; alkyl phenol ethoxylates (e.g. nonyl phenol polyether); salts and/or combinations thereof. The surfactants, when present, may be present in amounts from 0.01 wt % to 10 wt %, such as from 0.01 to 5 wt %, such as from 0.01 to 2 wt % based on the total solid weight of the coating composition.

The coating compositions may be substantially free, may be essentially free or may be completely free of bisphenol A (BPA) and derivatives thereof. Derivatives of bisphenol A include, for example, bisphenol A diglycidyl ether (BADGE). The coating compositions may be substantially free or completely free of bisphenol F (BPF) and derivatives thereof. Derivatives of bisphenol F include, for example, bisphenol F diglycidyl ether (BPFG). The compounds or derivatives thereof mentioned above may not be added to the coating composition intentionally but may be present in trace amounts because of unavoidable contamination from the environment. By “substantially free” we mean to refer to coating compositions containing less than 1000 parts per million (ppm) of any of the compounds or derivatives thereof mentioned above. By “essentially free” we mean to refer to coating compositions containing less than 100 ppm of any of the compounds or derivatives thereof mentioned above. By “completely free” we mean to refer to coating compositions containing less than 20 parts per billion (ppb) of any of the compounds or derivatives thereof.

The coating compositions may be substantially free, may be essentially free or may be completely free of dialkyltin compounds, including oxides or other derivatives thereof. Examples of dialkyltin compounds include, but are not limited to the following: dibutyltindilaurate (DBTDL); dioctyltindilaurate; dimethyltin oxide; diethyltin oxide; dipropyltin oxide; dibutyltin oxide (DBTO); dioctyltinoxide (DOTO) or combinations thereof. By “substantially free” we mean to refer to coating compositions containing less than 1000 parts per million (ppm) of any of the compounds or derivatives thereof mentioned above. By “essentially free” we mean to refer to coating compositions containing less than 100 ppm of any of the compounds or derivatives thereof mentioned above. By “completely free” we mean to refer to coating compositions containing less than 20 parts per billion (ppb) of any of the compounds or derivatives thereof.

The coating compositions may be substantially free of styrene. The coating compositions may be essentially free or may be completely free of styrene. By “substantially free” we mean to refer to coating compositions containing less than 1000 parts per million (ppm) of any of the compounds or derivatives thereof mentioned above. By “essentially free” we mean to refer to coating compositions containing less than 100 ppm of any of the compounds or derivatives thereof mentioned above. By “completely free” we mean to refer to coating compositions containing less than 20 parts per billion (ppb) of any of the compounds or derivatives thereof.

The coating compositions may be substantially phenol free, or essentially phenol free, or completely phenol free. By “substantially free” we mean to refer to coating compositions containing less than 1000 parts per million (ppm) of any of the compounds or derivatives thereof mentioned above. By “essentially free” we mean to refer to coating compositions containing less than 100 ppm of any of the compounds or derivatives thereof mentioned above. By “completely free” we mean to refer to coating compositions containing less than 20 parts per billion (ppb) of any of the compounds or derivatives thereof.

The coating compositions may be substantially formaldehyde free, or essentially formaldehyde free, or completely formaldehyde free. By “substantially free” we mean to refer to coating compositions containing less than 1000 parts per million (ppm) of any of the compounds or derivatives thereof mentioned above. By “essentially free” we mean to refer to coating compositions containing less than 100 ppm of any of the compounds or derivatives thereof mentioned above. By “completely free” we mean to refer to coating compositions containing less than 20 parts per billion (ppb) of any of the compounds or derivatives thereof.

The coating composition may have any suitable solids content. The coating composition may have a solids content of ≥10 by weight of the coating composition, such as ≥20 or ≥30%.The coating composition may have a solids content of ≤80% by weight of the coating composition, such as ≤70 wt % or ≤65 wt %. The coating composition may have a solids content of from 10 to 80% by weight of the coating composition, such as from 20 to 70 wt % or from 30 to 65 wt %.

The coating composition may exclude 2,2,4,4-tetramethyl-1-3-cyclobutane diol (“TMCD”). The definition of the polyol component and/or diol component may exclude 2,2,4,4-tetramethyl-1-3-cyclobutane diol (“TMCD”).

The substrate may be formed from any suitable material. The substrate may be a metal substrate. Suitable materials will be well known to a person skilled in the art. Suitable examples include, but are not limited to, the following: steel; tinplate; tin-free steel (TFS); galvanised steel, such as for example electro-galvanised steel; aluminium; aluminium alloy; and combinations thereof. The substrate may be formed from aluminium, steel, tinplate, tin-free steel (TFS), galvanised steel, such as for example electro-galvanised steel or combinations thereof. The substrate may be formed from aluminium, tinplate or tin-free steel (TFS), typically aluminium or tinplate.

The substrate may be a package coated at least in part with any of the coating compositions described above, such as a food and/or beverage package. A “package” is anything used to contain another item, particularly for shipping from a point of manufacture to a consumer, and for subsequent storage by a consumer. A package will be therefore understood as something that is sealed so as to keep its contents free from deterioration until opened by a consumer. The manufacturer will often identify the length of time during which the food or beverage will be free from spoilage, which typically ranges from several months to years. Thus, the present “package” is distinguished from a storage container or bakeware in which a consumer might make and/or store food; such a container would only maintain the freshness or integrity of the food item for a relatively short period. A package can be made of metal or non-metal, for example, plastic or laminate, and be in any form. Another example of a suitable package is metal can. The term “metal can” includes any type of metal can, container or any type of receptacle or portion thereof that is sealed by the food and/or beverage manufacturer to minimize or eliminate spoilage of the contents until such package is opened by the consumer. One example of a metal can is a food can; the term “food can(s)” is used herein to refer to cans, containers or any type of receptacle or portion thereof used to hold any type of food and/or beverage. The term “metal can(s)” specifically includes food cans and also specifically includes “can ends” including “E-Z open ends”, which are typically stamped from can end stock and used in conjunction with the packaging of food and beverages. The term “metal cans” also specifically includes metal caps and/or closures such as bottle caps, screw top caps and lids of any size, lug caps, and the like. The metal cans can be used to hold other items as well, including, but not limited to, personal care products, bug spray, spray paint, and any other compound suitable for packaging in an aerosol can. The cans can include “two piece cans” and “three-piece cans” as well as drawn and ironed one-piece cans. Such packaging could hold, for example, food, toothpaste, personal care products and the like.

Metal coils, having wide application in many industries, are also substrates that can be coated. Coil coatings also typically comprise a colorant.

In the uses defined above a coating composition is typically to coat surfaces and parts thereof. A part may include multiple surfaces. A part may include a portion of a larger part, assembly, or apparatus. A portion of a part may be coated with an aqueous composition or powder composition as defined herein or the entire part may be coated.

The application of various pre-treatments and coatings to packaging is well established. Such treatments and/or coatings, for example, can be used in the case of metal cans, wherein the treatment and/or coating is used to retard or inhibit corrosion, provide a decorative coating, provide ease of handling during the manufacturing process, and the like. Coatings can be applied to the interior of such cans to prevent the contents from contacting the metal of the container. Contact between the metal and a food or beverage, for example, can lead to corrosion of a metal container, which can then contaminate the food or beverage. This is particularly true when the contents of the can are acidic in nature. The coatings applied to the interior of metal cans also help prevent corrosion in the headspace of the cans, which is the area between the fill line of the product and the can lid; corrosion in the headspace is particularly problematic with food products having a high salt content. Coatings can also be applied to the exterior of metal cans.

The substrate may be new (i.e., newly constructed or fabricated) or it may be refurbished.

The coating compositions may be applied to the substrate, or a portion thereof, as a single layer or as part of a multi layer system. The coating composition may be applied as a single layer. The coating compositions may be applied to an uncoated substrate. For the avoidance of doubt an uncoated substrate extends to a surface that is cleaned prior to application. The coating compositions may be applied on top of another paint layer as part of a multi layer system. For example, the coating composition may be applied on top of a primer. The coating compositions may form an intermediate layer or a top coat layer. The coating composition may be applied as the first coat of a multi coat system. The coating composition may be applied as an undercoat or a primer. The second, third, fourth etc. coats may comprise any suitable paint such as those containing, for example, epoxy resins; polyester resins; polyurethane resins; polysiloxane resins; hydrocarbon resins or combinations thereof. The second, third, fourth etc. coats may comprise polyester resins. The second, third, fourth etc. coats may be a liquid coating or a powder coating.

It will be appreciated by a person skilled in the art that the coating composition may be applied before or after forming the article, such as the packaging. For example, the coating composition may be applied to metal substrate which is then shaped and formed into a metal article, or the coating composition may be applied to the preformed article.

The coating compositions may be applied to a substrate once or multiple times.

The coating compositions may be applied to the substrate by any suitable method. Methods of applying the coating compositions will be well known to a person skilled in the art. Suitable application methods for the coating compositions include, but are not limited to the following: electrocoating; spraying; electrostatic spraying; dipping; rolling; brushing; and the like.

The coating compositions may be applied to any suitable dry film thickness. The coating compositions may be applied to a dry film thickness from 2 to 40 microns (μm).

It will also be understood that the substrate may be pretreated with a pretreatment composition, such as a pre-treatment solution. Non-limiting examples of a pretreatment composition include a zinc phosphate pretreatment solution such as, for example, those described in U.S. Pat. Nos. 4,793,867 and 5,588,989, a zirconium containing pretreatment solution such as, for example, those described in U.S. Pat. Nos. 7,749,368 and 8,673,091. Other non-limiting examples of a pretreatment composition include those comprising trivalent chromium, hexavalent chromium, lithium salts, permanganate, rare earth metals, such as yttrium, or lanthanides, such as cerium. Another non-limiting example of a suitable surface pretreatment composition is a sol-gel, such as those comprising alkoxy-silanes, alkoxy-zirconates, and/or alkoxy-titanates. Alternatively, the substrate may be a non-pretreated substrate, such as a bare substrate, that is not pretreated by a pretreatment composition.

The coating composition, pretreatment composition and/or layers deposited from the same, such as a pretreatment layer, primer layer or topcoat layer, substrate and/or coated substrate or part thereof, may be substantially free of hexavalent-chromium compounds meaning that hexavalent-chromium or hexavalent-chromium-containing compounds are not intentionally added, but may be present in trace amounts, such as because of impurities or unavoidable contamination from the environment. In other words, the amount of material is so small that it does not affect the properties of the composition; this may further include that hexavalent-chromium or hexavalent-chromium-containing compounds are not present in an aqueous or powder composition and/or layers deposited from the same, as well as any pretreatment layer, primer layer or topcoat layer, in such a level that they cause a burden on the environment. The coating composition, pretreatment composition and/or layers deposited from the same, such as a pretreatment layer, primer layer or topcoat layer, substrate and/or coated substrate or part thereof, may be essentially free, or completely free of hexavalent-chromium compounds. Non-limiting examples of such chromium-containing compounds include chromic acid, chromium trioxide, chromic acid anhydride; chromate salts, such as ammonium chromate, sodium chromate, potassium chromate, and calcium, barium, magnesium, zinc, cadmium, and strontium chromate; and dichromate salts, such as ammonium dichromate, sodium dichromate, potassium dichromate, and calcium, barium, magnesium, zinc, cadmium, and strontium dichromate. The substantially free, essentially free, or completely hexavalent chromium free substrate or coated substrate may or may not have undergone a pre-treatment process. When the substrate or coated substrate has undergone a pre-treatment process involving passivation, the passivation solutions used may be substantially free, may be essentially free or may be completely free of hexavalent-chromium compounds. Therefore, the passivation process may not comprise hexavalent-chromium compounds. For example, the passivation process may not comprise contacting or immersing a substrate, such as a tinplate sheet with and/or in a solution comprising hexavalent-chromium compounds. The substrate may comprise an aluminium, tin free steel or tinplate substrate that is substantially free, essentially free, or completely free of hexavalent-chromium.

The term “substantially free” means that a coating composition and/or layers deposited from the same, as well as any pretreatment layer, primer layer or topcoat layer, contain less than 10 ppm of hexavalent-chromium, based on total solids weight of the composition, the layer, or the layers, respectively, if any at all. The term “essentially free” means that a coating composition and/or layers deposited from the same, as well as any pretreatment layer, primer layer or topcoat layer, contain less than 1 ppm of hexavalent-chromium, based on total solids weight of the composition or the layer, or layers, respectively, if any at all. The term “completely free” means that a coating composition and/or layers comprising the same, as well as any pretreatment layer, primer layer or topcoat layer, contain less than 1 ppb of hexavalent-chromium, based on total solids weight of the composition, the layer, or the layers, respectively, if any at all.

The invention may comprise a trivalent-chromium pretreated substrate, such as a substantially hexavalent-chromium compound free trivalent-chromium pretreated substrate. As such, the passivation process may comprise trivalent-chromium compounds. The trivalent chromium compound may comprise chromium(III) fluoride. For example, the passivation process may comprise contacting or immersing a substrate, such as a tinplate sheet with and/or in a solution comprising trivalent-chromium compounds. The substrate may comprise an aluminium, tin free steel or tinplate substrate that is a trivalent-chromium pretreated substrate.

The passivation process may comprise any passivation 505 or 555 method from Arcelor, Tata, TKS or US Steel, it may also comprise any passivation method that would be based on Henkel Bonderite 1456, applied by any tin mill from any country. The pretreatment may be according to Henkel NR 6207. Substantially hexavalent-chromium free tinplate may be obtained from a commercial source.

The substrate may optionally be subjected to other treatments prior to coating. For example, the substrate may be cleaned, cleaned and deoxidized, anodized, acid pickled, plasma treated, laser treated, or ion vapor deposition (IVD) treated. These optional treatments may be used on their own or in combination with a pretreatment composition.

The coating composition may be cured by any suitable method. The coating composition may be cured by heat curing, radiation curing, or by chemical curing, such as by heat curing. The coating composition, when heat cured, may be cured at any suitable temperature. The coating composition, when heat cured, may be cured to a peak metal temperature (PMT) of 150 to 350° C., such as from 175 to 320° C., such as from 190 to 300° C., or even from 200 to 280° C. The coating composition, when heat cured, may be cured at 210° C. or at 260° C. For the avoidance of doubt, the term “peak metal temperature”, and like terms as used herein, is meant unless specified otherwise the maximum temperature reached by the metal substrate during exposure to a heat during the heat curing process. In other words, the peak metal temperature (PMT) is the maximum temperature reached by the metal substrate and not the temperature which is applied thereto. It will be appreciated by a person skilled in the art that the temperature reached by the metal substrate may be lower than the temperature which is applied thereto or may be substantially equal to the temperature which is applied thereto. The temperature reached by the metal substrate may be lower that the temperature which is applied thereto.

Curing the coating compositions may form a cured film.

For the purpose of the present invention, an aliphatic group is a hydrocarbon moiety that may be straight chain (i.e. unbranched), branched, or cyclic and may be completely saturated, or contain a unit of unsaturation, but which is not aromatic. The term “unsaturated” means a moiety that has a double and/or triple bond. The term “aliphatic” is therefore intended to encompass alkyl, cycloalkyl, alkenyl cycloalkenyl, alkynyl or cycloalkenyl groups, and combinations thereof. The term “(hetero)aliphatic” encompasses both an aliphatic group and/or a heteroaliphatic group.

An aliphatic group is optionally a C₁-30 aliphatic group, that is, an aliphatic group with 1, 2, 3,4, 5, 6, 7, 8, 9, 10, 11, 12,13, 14, 15, 16, 17, 18, 19, 20, 21, 22, 23, 24, 25, 26,27, 28, 29 or 30 carbon atoms. Optionally, an aliphatic group is a C₁₋₁₅ aliphatic, optionally a C₁₋₁₂ aliphatic, optionally a C₁₋₁₀ aliphatic, optionally a C₁₋₈ aliphatic, such as a C₁₋₆aliphatic group. Suitable aliphatic groups include linear or branched, alkyl, alkenyl and alkynyl groups, and mixtures thereof such as (cycloalkyl)alkyl groups, (cycloalkenyl)alkyl groups and (cycloalkyl)alkenyl groups.

A heteroaliphatic group (including heteroalkyl, heteroalkenyl and heteroalkynyl) is an aliphatic group as described above, which additionally contains a heteroatom. Heteroaliphatic groups therefore optionally contain from 2 to 21 atoms, optionally from 2 to 16 atoms, optionally from 2 to 13 atoms, optionally from 2 to 11 atoms, optionally from 2 to 9 atoms, optionally from 2 to 7 atoms, wherein an atom is a carbon atom. Optional heteroatoms are selected from O, S, N, P and Si. When heteroaliphatic groups have two or more heteroatoms, the heteroatoms may be the same or different. Heteroaliphatic groups may be substituted or unsubstituted, branched or unbranched, cyclic or acyclic, and include saturated, unsaturated or partially unsaturated groups.

The term “alkyl” and “alk” as used herein, refers to saturated, straight- or branched-chain hydrocarbon radicals derived by removal of a single hydrogen atom from an aliphatic moiety. An alkyl group is optionally a “C₁₋₂₀ alkyl group”, that is an alkyl group that is a straight or branched chain with 1 to 20 carbons. The alkyl group therefore has 1, 2, 3, 4, 5, 6, 7, 8, 9, 10, 11, 12, 13, 14, 15, 16, 17, 18, 19 or 20 carbon atoms. Optionally, an alkyl group is a C₁₋₁₅ alkyl, optionally a C₁₋₁₂ alkyl, optionally a C₁₋₁₀ alkyl, optionally a C₁₋₈ alkyl, optionally a C₁₋₆ alkyl group. Specifically, examples of “C₁₋₂₀ alkyl group” include methyl group, ethyl group, n-propyl group, iso-propyl group, n-butyl group, iso-butyl group, sec-butyl group, tert-butyl group, sec-pentyl, iso-pentyl, n-pentyl group, neopentyl, n-hexyl group, sec-hexyl, n-heptyl group, n-octyl group, n-nonyl group, n-decyl group, n-undecyl group, n-dodecyl group, n-tridecyl group, n-tetradecyl group, n-pentadecyl group, n-hexadecyl group, n-heptadecyl group, n-octadecyl group, n-nonadecyl group, n-eicosyl group, 1,1-dimethylpropyl group, 1,2-dimethylpropyl group, 2,2-dimethylpropyl group, 1-ethylpropyl group, n-hexyl group, 1-ethyl-2-methylpropyl group, 1,1,2-trimethylpropyl group, 1-ethylbutyl group, 1-methylbutyl group, 2-methylbutyl group, 1,1-dimethylbutyl group, 1,2-dimethylbutyl group, 2,2-dimethylbutyl group, 1,3-dimethylbutyl group, 2,3-dimethylbutyl group, 2-ethylbutyl group, 2-methylpentyl group, 3-methylpentyl group and the like.

The term “alkenyl,” as used herein, denotes a group derived from the removal of a single hydrogen atom from a straight- or branched-chain aliphatic moiety having a carbon-carbon double bond. The term “alkynyl,” as used herein, refers to a group derived from the removal of a single hydrogen atom from a straight- or branched-chain aliphatic moiety having a carbon-carbon triple bond. Alkenyl and alkynyl groups are optionally “C₂₋₂₀alkenyl” and “C₂₋₂₀alkynyl”, optionally “C₂₋₁₅ alkenyl” and “C₂₋₁₅alkynyl”, optionally “C₂₋₁₂ alkenyl” and “C₂₋₁₂ alkynyl”, optionally “C₂₋₁₀ alkenyl” and “C₂₋₁₀ alkynyl”, optionally “C₂₋₃ alkenyl” and “C₂₋₃ alkynyl”, optionally “C₂₋₆ alkenyl” and “C₂₋₆ alkynyl” groups, respectively. Examples of alkenyl groups include ethenyl, propenyl, allyl, 1,3-butadienyl, butenyl, 1-methyl-2-buten-1-yl, allyl, 1,3-butadienyl and allenyl. Examples of alkynyl groups include ethynyl, 2-propynyl (propargyl) and 1-propynyl.

The terms “cycloaliphatic”, “carbocycle”, or “carbocyclic” as used herein refer to a saturated or partially unsaturated cyclic aliphatic monocyclic or polycyclic (including fused, bridging and spiro-fused) ring system which has from 3 to 20 carbon atoms, that is an alicyclic group with 3, 4, 5, 6, 7, 8, 9, 10, 11, 12, 13, 14, 15, 16, 17, 18, 19 or 20 carbon atoms. Optionally, an alicyclic group has from 3 to 15, optionally from 3 to 12, optionally from 3 to 10, optionally from 3 to 8 carbon atoms, optionally from 3 to 6 carbons atoms. The terms “cycloaliphatic”, “carbocycle” or “carbocyclic” also include aliphatic rings that are fused to an aromatic or nonaromatic ring, such as tetrahydronaphthyl rings, where the point of attachment is on the aliphatic ring. A carbocyclic group may be polycyclic, e.g. bicyclic or tricyclic. It will be appreciated that the alicyclic group may comprise an alicyclic ring bearing a linking or non-linking alkyl substituent, such as —CH₂-cyclohexyl. Specifically, examples of carbocycles include cyclopropane, cyclobutane, cyclopentane, cyclohexane, bicycle[2,2,1]heptane, norborene, phenyl, cyclohexene, naphthalene, spiro[4.5]decane, cycloheptane, adamantane and cyclooctane.

An alicyclic group is a saturated or partially unsaturated cyclic aliphatic monocyclic or polycyclic (including fused, bridging and spiro-fused) ring system which has from 3 to 20 carbon atoms, that is an alicyclic group with 3, 4, 5, 6, 7, 8, 9, 10, 11, 12, 13, 14, 15, 16, 17, 18, 19 or 20 carbon atoms. Optionally, an alicyclic group has from 3 to 15, optionally from 3 to 12, optionally from 3 to 10, optionally from 3 to 8 carbon atoms, optionally from 3 to 6 carbons atoms. The term “alicyclic” encompasses cycloalkyl, cycloalkenyl and cycloalkynyl groups. It will be appreciated that the alicyclic group may comprise an alicyclic ring bearing a linking or non-linking alkyl substituent, such as —CH₂-cyclohexyl. Specifically, examples of the C₃₋₂₀ cycloalkyl group include cyclopropyl, cyclobutyl, cyclopentyl, cyclohexyl, cycloheptyl, adamantyl and cyclooctyl.

An aryl group or aryl ring is a monocyclic or polycyclic ring system having from 5 to 20 carbon atoms, wherein a ring in the system is aromatic and wherein each ring in the system contains three to twelve ring members. An aryl group is optionally a “C₆₋₁₂ aryl group” and is an aryl group constituted by 6, 7, 8, 9, 10, 11 or 12 carbon atoms and includes condensed ring groups such as monocyclic ring group, or bicyclic ring group and the like. Specifically, examples of “C₆₋₁₀ aryl group” include phenyl group, biphenyl group, indenyl group, anthracyl group, naphthyl group or azulenyl group and the like. It should be noted that condensed rings such as indan, benzofuran, phthalimide, phenanthridine and tetrahydro naphthalene are also included in the aryl group.

As used herein, unless otherwise expressly specified, all numbers such as those expressing values, ranges, amounts or percentages may be read as if prefaced by the word “about”, even if the term does not expressly appear. The term “about” when used herein means+/−10% of the stated value.

The recitation of numerical ranges by endpoints includes all integer numbers and, where appropriate, fractions subsumed within that range (e.g. 1 to 5 can include 1, 2, 3, 4 when referring to, for example, a number of elements, and can also include 1.5, 2, 2.75 and 3.80, when referring to, for example, measurements). The recitation of end points also includes the end point values themselves (e.g. from 1.0 to 5.0 includes both 1.0 and 5.0). When ranges are given, any endpoints of those ranges and/or numbers within those ranges can be combined within the scope of the present invention.

Singular encompasses plural and vice versa. For example, although reference is made herein to “a” polyester material, “a” feathering reducing agent, “a” crosslinker, and the like, one or more of each of these and any other components can be used.

As used herein, the term “polymer” refers to oligomers and both homopolymers and copolymers, and the prefix “poly” refers to two or more.

“Including”, “for example” and like terms means including but not limited to. Similarly, as used herein, the terms “on”, “applied on/over”, “formed on/over”, “deposited on/over”, “overlay” and “provided on/over” mean formed, overlay, deposited, or provided on but not necessarily in contact with the surface. For example, a coating layer “formed over” a substrate does not preclude the presence of one or more other coating layers of the same or different composition located between the formed coating layer and the substrate.

The terms “comprising”, “comprises” and “comprised of” as used herein are synonymous with “including”, “includes” or “containing”, “contains”, and are inclusive or open-ended and do not exclude additional, non-recited members, elements or method steps. Additionally, although the present invention has been described in terms of “comprising”, the processes, materials, and coating compositions detailed herein may also be described as “consisting essentially of” or “consisting of”. For example, while the invention has been described in terms of a coating comprising a polyester binder material and a feathering reducing agent, a coating consisting essentially of and/or consisting of a polyester binder material and a feathering reducing agent is also within the present scope. In this context, ‘consisting essentially of’ means that any additional coating components will not materially affect the feathering property of the coating. Where a material is described as being “obtainable by”, the material may also be described as “obtained by”.

As used herein, the term “and/or,” when used in a list of two or more items, means that any one of the listed items can be employed by itself or any combination of two or more of the listed items can be employed. For instance, if a list is described as comprising group A, B, and/or C, the list can comprise A alone; B alone; C alone; A and B in combination; A and C in combination, B and C in combination; or A, B, and C in combination. For example, the coating composition may comprise a feathering reducing agent, selected from (i) an acrylic feathering reducing agent comprising a functional group selected from hydroxyl, epoxide, phosphatized epoxide and/or acid-functional; (ii) a hydroxy-functional polyester feathering reducing agent; (iii) feathering reducing agent comprising a functional group selected from amine, amide, imine and/or nitrile; (iv) a phosphatized epoxy feathering reducing agent; (v) a phenolic resin feathering reducing agent; and/or (vi) a feathering reducing agent comprising an oxazolyl functional group, and the coating composition may comprise agent (i) alone, (ii) alone, (iii) alone, (iv) alone, (v) alone, (vi) alone; (i) and (ii) in combination, (i) and (iii) in combination, (i) and (iv) in combination, (i) and (v) in combination, (i) and (vi) in combination, (i), (ii) and (iii) in combination, etc.

Where ranges are provided in relation to a genus, each range may also apply additionally and independently to any one or more of the listed species of that genus. For example, the invention may comprise from 0.1 to 40% of an acrylic feathering agent, by total solid weight of the composition, which acrylic feathering agent comprises an epoxide-functional acrylic feathering reducing agent in an amount such that the composition comprises from 0.1 to 40% of an epoxide-functional acrylic feathering reducing agent, by total solid weight of the composition. Similarly, the invention may comprise from 0.1 to 40% of acrylic feathering agent, by total solid weight of the composition, which acrylic feathering agent comprises an epoxide-functional acrylic feathering reducing agent and an oxazolyl-functional acrylic feathering reducing agent in an amount such that the composition comprises from 0.1 to 40% of each of an epoxide-functional acrylic feathering reducing agent and an oxazolyl-functional acrylic feathering reducing agent, by total solid weight of the composition. A further example may be wherein the invention comprises from 0.1 to 40% of an acrylic feathering agent, by total solid weight of the composition, which an acrylic feathering agent comprise an epoxide-functional acrylic feathering reducing agent and an oxazolyl-functional acrylic feathering reducing agent in an amount such that the composition comprises ≥0.1 of an epoxide-functional acrylic feathering reducing agent, by total solid weight of the composition. Further, for example, the invention may comprise from 0.1 to 40% of an acrylic feathering agent, by total solid weight of the composition, which acrylic feathering agent comprise an epoxide-functional acrylic feathering reducing agent and an oxazolyl-functional acrylic feathering reducing agent in an amount such that the composition comprises ≤20% of an epoxide-functional acrylic feathering reducing agent, by total solid weight of the composition. Furthermore, a species of a genus, such as an epoxide-functional acrylic feathering reducing agent, may also be a sub-genus for a further sub-species, such as an epoxide-and-hydroxy-functional acrylic feathering reducing agent. For example, the invention may comprise from 0.1 to 40% of an acrylic feathering agent, by total solid weight of the composition, which acrylic feathering agent comprise an epoxide-functional acrylic feathering reducing agent in an amount such that the composition comprises from 0.1 to 40% of an epoxide-functional acrylic feathering reducing agent, by total solid weight of the composition, and which an epoxide-functional acrylic feathering reducing agent comprise epoxide-and-hydroxy-functional acrylic feathering reducing agent in an amount such that the composition comprises from ≥0.1 of epoxide-and-hydroxy-functional acrylic feathering reducing agent. Further examples of the abovementioned include the ranges provided for the polyester binder material, hydroxy-functional polyester feathering reducing agent, a feathering reducing agent comprising a functional group selected from amine, amide, imine and/or nitrile; and/or a phosphatized epoxy feathering reducing agent and all associated species, sub-genera and sub species.

All of the features contained herein may be combined with any of the above in any combination.

For a better understanding of the invention, and to show how embodiments of the same may be carried into effect, reference will now be made, by way of example, to the following experimental data.

### Examples

### Polyester 1

Polyester 1 was formed as follows.

The diol, diacid and catalyst listed in Table 1 were added as a batch to a vessel with a steam column, distillation head and condenser. The batch temperature was increased to 180° C. with continuous stirring at 400 rpms and a nitrogen gas blanket at 0.5 SCFH. Then the batch temperature was increased to 230° C. in 10° C. steps each hour over a 5 hour period. The temperature of the vapor was monitored continuously and the batch temperature was not raised for each step until the vapor temperature had dropped below 80° C. Once the reaction temperature had reached 230° C. the acid value (AV which is defined as the mg KOH needed to neutralize 1 gram of resin) of the polymer was checked every hour until it dropped below a value of 20. When the resin changed from cloudy to transparent in nature the blanket was switched to a 0.5 SCFH sparge. Once at an AV less than 20 the sparge was switched back to a blanket and the reaction was cooled to 150° C. The MeHQ was added first, followed by the maleic anhydride 10 minutes later. The reaction temperature was raised back to 220° C., sparge re-applied, and monitored by manual sampling of the resin and analysis by AV measurements every couple of hours. Once the acid value had dropped below 20 the reaction was cooled to 130° C., then xylene was added by an addition funnel under a nitrogen blanket of 0.5 SCFH. After the xylene had been added the reaction overheads were switched to an azeotropic distillation setup with extra xylene added to the attached Dean-Stark trap. The reaction was heated up again to 220° C. and a 0.5 SCFH nitrogen gas sparge was re-applied to the reaction. The reaction was monitored by AV by acquiring samples of the xylene-containing resin and reducing the solids of that material to a % solids that would allow for a comparison against standardized bubble tube references (references supplied by Gardco and all bubble tube samples cooled to 25° C. before analysis). This “cut-viscosity” was used to assess the extent of the polymerization and a bubble tube viscosity of Z4-Z5 at 55% solids was defined as the primary target. An acid value below 10 was defined as the secondary target. Once the cut-viscosity had been achieved (4 hours after xylene addition) the reaction was sampled for AV, hydroxyl value content and molecular weight as analyzed by gel permeation chromatography (GPC) vs. polystyrene standards. The resin was cooled to 130° C. and Dowanol DPM solvent was added. After 1 hour the final solvated material was poured out and analyzed for its molecular weight as analyzed by gel permeation chromatography (GPC) vs. polystyrene standards and glass transition temperature as assessed by Differential Scanning Calorimetry (DSC).

TABLE 1
polyester 1

| | Amount (grams) |
|---|---|
| Neopentyl glycol | 419.40 |
| 1,4-Cyclohexanedimethanol | 578.80 |
| Isophthalic acid | 821.60 |
| Terephthalic acid | 408.80 |
| Stannous octoate | 3.8550 |
| MeHQ | 0.41 |
| Maleic Anhydride | 40.60 |
| Xylene | 83.30 |
| Dowanol DPM | 1098.10 |
| Initial Weight | 2273.08 |
| Theoretical Water Loss | 274.33 |
| Final Resin Weight | 1998.75 |
| % Solids | 62.66 |
| Mn (number average molecular weight) | 4938 |
| Mw (weight average molecular weight) | 12242 |
| PDI | 2.5 |
| AV (96% solids, pre-solvation) | 10.71 |
| OH (96% solids, pre-solvation) | 7.70 |
| Glass Transition Temp (° C.) | 60.00 |

### Acrylic Polyester Resin

The acrylic polyester resin was formed from polyester 1 as follows.

Polyester 1 of the amount specified in Table 2 was added to a round-bottomed flask and enough Dowanol DPM was added to reduce the theoretical solids to 59%. The material was heated to 130° C. under continuous stirring at 400 rpms under a 0.5 SCFH nitrogen gas blanket. The methacrylic monomers shown in the table were mixed together, then added to the reaction via addition funnel over a 60 minute period. After 20 minutes a mixture of 2/3 of the initiator from the table was diluted with Dowanol DPM and was added via addition funnel over a 40 minute period. Both the monomer and initator separate feeds ended at the same time. Once this occurred the remaining 13 of the initiator was diluted with Dowanol DPM and added over a 5 minute period. The reaction was held at 130° C. for a 2 hour period. After the hold the PGA resin was poured out and analyzed for acid value (AV) and molecular weight using gel permeation chromatography (GPC) vs. polystyrene standards.

TABLE 2
acrylic polyester resin

| | Amount (grams) |
|---|---|
| Polyester 1 | 1326.33 |
| Methacrylic Acid | 40.74 |
| Butyl Methacrylate | 74.69 |
| 2-Hydroxyethyl Methacrylate | 20.37 |
| Dowanol DPM | 174.62 |
| t-Butyl peroxyacetate, 50% solution | 13.26 |
| in mineral spirits | |
| Final Resin Weight | 1650.00 |
| % Polyester | 85.37 |
| % Acrylic | 13.95 |
| % Initiator | 0.68 |
| AV | 22 |
| Mn | 4663 |
| Mw | 13995 |

The acrylic modified polyester resin was formed into an aqueous dispersion by heating the resin to 90° C. and adding dimethylethanolamine with continuous stirring at 400 rpm and a 0.5 SCFH nitrogen gas blanket. The mixture was allowed to stir for 10 minutes, then deionized water that had been pre-heated to 60° C. was added over a 60-minute period. The aqueous dispersion was allowed to cool to 45° C. before being filtered through a 5 μm filter bag. The aqueous dispersion was analysed for AV and particle size.

TABLE 3
acrylic polyester resin dispersion

| | Amount (grams) |
|---|---|
| Acrylic polyester resin | 1531.57 |
| Dimethylethanolamine | 35.18 |
| Deionized Water | 718.92 |
| % Solids | 39.72 |
| AV | 14.47 |
| Particle Size (Mastersizer, μm) | 0.463 |

### GMA Acrylic Resin

The GMA acrylic resin feathering reducing agent was formed as follows.

Polymerisation was carried out in a reactor equipped with heating, stirring and a water-cooled reflux condenser. A sparge of nitrogen was applied to the reactor to provide an inert atmosphere. 488.41 grams of butyl cellosolve and 134.37 grams of n-butanol were charged to the reactor and heated to reflux at a temperature of 150 to 160° C. with stirring. A monomer mixture containing 800.00 grams of glycidyl methacrylate, 464.00 grams of isobutyl methacrylate, 16 grams of 2-ethylhexyl methacrylate, 320 grams of 4-hydroxylbutyl acrylate and an initiator mixture comprising 106.67 grams of t-butylperoxy 2-ethylhexanoate and 106.67 grams of butyl cellosolve were prepared separately and added to a monomer tank and an initiator tank, respectively. The monomer mixture was added to the reactor at a temperature of 150° C. over a period of 150 minutes. The initiator mixture was also added to the reactor at the same temperature but over a period of 180 mins, with the beginning of the initiator mixture charge starting 5 minutes after the monomer mixture had begun being charged to the reactor. At the end of monomer feed, 65 grams of Dowanol DPM was used to rinse the monomer tank. At the end of the initiator feed, the reactor was cooled to 130° C. and held at 130° C. for 30 mins. After holding, the chaser (a mixture of 16.00 grams of t-butylperoxy 2-ethylhexanoate and 32.00 grams of butyl cellosolve) was added over a period of 30 minutes and followed by adding 67.20 grams of Dowanol DPM for rinse. The reactor was then held for 60 minutes at 130° C. After this time, the reactor (containing the reaction mixture) was allowed to cool by removing the heat.

The resultant acrylic pre-polymer was then removed from the reactor when hot. The acrylic pre-polymer was 65.1% weight solids and had a Tg of 27° C.

TABLE 4
GMA acrylic

| Component | Amount (grams) |
|---|---|
| butyl cellosolve | 488.41 |
| butanol | 134.37 |
| t-butylperoxy 2-ethylhexanoate | 106.67 |
| butyl cellosolve | 106.67 |
| GMA | 800.00 |
| isobutyl methacrylate | 464.00 |
| ethylhexyl methacrylate | 16.00 |
| 4-hydroxylbutyl acrylate | 320.00 |
| downaol dpm | 67.20 |
| t-butylperoxy 2-ethylhexanoate | 16.00 |
| butyl cellosolve | 32.00 |
| downaol dpm | 67.20 |

Comparative Example 1 and Examples 1 to 4 were prepared by combining the materials of Table 5 under mixing for 15 minutes with a mixing blade.

Coated panels were obtained by drawing the coating composition over trivalent chromium pretreated NR6207 aluminum panels (AA5182 Alloy) using a wire wound rod to obtain dry coating weight of approximately 6.5 to 7.0 mg/square inch (msi). Coated panels were then immediately placed into a three-zone, gas-fired, conveyor oven for 10 seconds and baked to a peak metal temperature of 465° F. (240.5° C.).

TABLE 5
coating compositions

| | Solids | Comp. | | | | |
|---|---|---|---|---|---|---|
| | % | Ex. 1 | Ex. 1 | Ex. 2 | Ex. 3 | Ex. 4 |
| Acrylic polyester resin | 39 | 268.487 | 50.570 | 53.206 | 50.495 | 53.287 |
| Triethylene Glycol¹ | 0 | 25.436 | 4.791 | 5.041 | 7.372 | 5.048 |
| Primary Amyl Alcohol¹ | 0 | 2.034 | 0.383 | 0.403 | 0.383 | 0.404 |
| Additol XW 395² | 59 | 6.725 | 1.267 | 1.333 | 1.265 | 1.335 |
| Cymel 1123³ | 100 | 19.899 | 3.748 | 3.943 | 3.742 | 3.949 |
| Nacure 5925⁴ | 25 | 0.519 | 0.098 | 0.103 | 0.098 | 0.103 |
| Michem Emulsion | 40 | 3.319 | 0.625 | 0.658 | 0.624 | 0.659 |
| 48040M2⁵ | | | | | | |
| Aquacer 1547⁶ | 35 | 0.934 | 0.176 | 0.185 | 0.176 | 0.185 |
| DI Water | 0 | 22.648 | 4.266 | 4.488 | 4.259 | 4.495 |
| Epocros WS500⁷ | 39 | | 4.077 | | | |
| GMA acrylic resin | 65 | | | 0.641 | | |
| Tego LP1600⁸ | 100 | | | | 1.587 | |
| Dicyandiamide⁹ | 10 | | | | | 0.535 |
| Total | | 350 | 70 | 70 | 70 | 70 |

¹solvent from Dow Chemical
²silicone-free wetting agent from Allnex
³benzoguanamine resin from Allnex
⁴blocked catalyst from King
⁵Microcrystalline wax from Michelman
⁶Anionic emulsion of oxidized polyethylene wax from BYK
⁷Oxazoline functional resin from Nippon Shokubai
⁸OH functional polyester resin from Evonik Industries
⁹10% dicyandiamide in ethylene glycol

Feathering: The feathering property of the coatings was evaluated by following test protocol 1 described above.

Wedge bend: Flexibility of the coatings was evaluated using a wedge bend test. Coated panels were cut into 2 inch by 4 inch pieces, with the substrate grain running perpendicular to the long length of the cut panel. They were then bent over a ⅛ inch metal rod along the long length of the panel with the coated side facing out. Bent coupons were then placed onto a block of metal where a wedge was pre-cut out of it with a taper of 0 to ⅛ inch along a 4 inch length. Once placed in the wedge, each bent coupon was struck with a block of metal which weighed 4 pounds from a height of 12 inches to form a wedge where one end of the coated metal impinged upon itself and a ⅛ inch space remained on the opposite end. Wedge bent panels were then placed into an aqueous solution of copper sulfate and hydrochloric acid for one minute to purposely etch the aluminum panel in areas where the coatings failed and cracked. The etched wedge bent panels were then examined through a microscope at 1 Ox power to determine how far from the impinged end along the bent radii did the coating crack. Flexibility results are reported as either the length of cracked area from the impinged end or the percentage of cracked area versus total length of the wedge bent panel.

Blush: Coatings were evaluated for their ability to resist blushing and to adhere to the aluminum panels in deionized water retort test. Coated panels were cut into 2 inch by 4 inch pieces, half immersed into deionized water, and then placed in a steam retort for 30 minutes at 250° F. Panels were then cooled in deionized water, dried, and immediately rated for blush and adhesion. Blush was rated visually using a scale of 1-10 where a rating of “10” indicates no blush and “0” indicates complete whitening of the film.

Results of these tests are reported in Table 6.

TABLE 6
coating properties

| | Feathering |
|---|---|
| Comparative Example 1 | 0.95 |
| Example 1 | 0.37 |
| Example 2 | 0.08 |
| Example 3 | 0.32 |
| Example 4 | 0.00 |

TABLE 7
coating properties

| | Wedge Bend (mm) | Blush |
|---|---|---|
| Comparative Example 1 | 3 | 5.5 |
| Example 1 | 5 | 4.5 |
| Example 2 | 7 | 5.0 |
| Example 3 | 5 | 5.5 |

### Polyester 2

Polyester 2 was prepared as follows.

Reactor was set for packed column with head temperature, condenser turned on and nitrogen on sparge. Charges #1, 2, 3, 4 as detailed in Table 8 were added to the reactor. The reactor was slowly heated to 160° C. (320° F.). The temperature was then increased to a maximum reactor temperature of 245° C. (473° F.), not allowing column temperature to exceed 96° C. (205° F.). A steady rate of distillation was maintained until the material was clear and showed an acid value of 5 or below. The material was when cooled to 160° C. (320° F.). Charges #5, 6, 7, 8 and 9 were then added to the reactor and the reactor heated to 200° C. (392° F.). The temperature was then increased to a maximum reactor temperature 245° C. (473° F.) not allowing column temperature to exceed 96° C. (206° F.). A steady rate of distillation was maintained until the material was clear and showed an acid value of 20 or below. The reactor temperature was then lowered to 180° C. Charge #10 was then pumped into the reactor. A azeotropic distillation was set up over a packed column and the decanter was filled with Aromatic 100. The temperature was increased to maintain a steady reflux with the temperature not exceeding 245° C. In-process sample cuts were made in the ratio of: 10 grams sample (@ 96% solids) from reactor with 7.32 grams of N-METHYL-2-PYRROLIDONE to solids of 55%. The material was processed until it showed an acid value of 4.00 in solution and viscosity of Z6+. The temperature was then lowered to 160° C. (320° F.) and charges #11, 12 and 13 were then added slowly and allowed to mix for 1 hour. The material was then filtered through a 5 micron bag. The resulting number average molecular weight of this polyester was 12,063.

TABLE 8
Polyester 2

| Charge # | Type | Component | Amount |
|---|---|---|---|
| Charge 1 | Reactant | 2-methyl-1,3-propanediol | 539.26 |
| Charge 2 | Catalyst | tetra n-butyl titanate | 2.5 |
| Charge 3 | Reactant | dimethyl 2,6 naphthalene dicarboxyl | 883.76 |
| Charge 4 | Reactant | trimethylol propane | 11.62 |
| Charge 5 | Reactant | isophthalic acid | 615.78 |
| Charge 6 | Reactant | 2-methyl-1,3-propanediol | 381.91 |
| Charge 7 | Reactant | adipic acid | 331.95 |
| Charge 8 | Reactant | maleic anhydride | 32.2 |
| Charge 9 | Catalyst | stannous 2-ethylhexoate | 1.4 |
| Charge 10 | Solvent | aromatic solvent-100 type | 612 |
| Charge 11 | Solvent | aromatic solvent-100 type | 147.4 |
| Charge 12 | Solvent | 2-butoxyethanol | 750 |
| Charge 13 | Solvent | methyl ether propylene glycol acetate | 490 |

### Acidic Polyester Additive

An acidic polyester additive was prepared as follows:

Trimethylolpropane and 2-methyl 1,3-propane diol were charged in a reaction vessel equipped with an agitator, a nitrogen blanket and a distillation set up and heated to 50° C. Once the temperature was reached isophthalic acid, dibutyl tin oxide, maleic anhydride and phthalic anhydride were then added to the vessel and slowly heated to distillation. The mixture was esterified under a nitrogen atmosphere over a period of twelve (12) hours at a temperature ranging from 180° C. and 240° C. When the acid value of the mixture dropped to 13.00 mg of KOH/g, the mixture was cooled to 160° C. and then the AROMATIC 100 solvent (i.e., an aromatic hydrocarbon solvent blend commercially available from Exxon Mobil) was incorporated for azeotropic distillation of water evolved as a condensate by-product. Thereafter, the phosphoric acid solution and water were added and the azeotropic distillation of water was continued until the acid value of the mixture dropped to below 20 mg of KOH/g. The resulting phosphatized polyester resin was then dissolved in the 2-butoxyethanol and monobutyl ether of diethylene glycol to produce a composition which was 50 percent by weight solids.

The number average molecular weight of the resulting phosphatized polyester was 4,500, the acid value was 20 and the hydroxyl value was 80 based on resin solids. The equivalent ratio of P—OH to OH in the polyester was 1:2.3.

TABLE 9
acidic polyester additive

| Component | Parts by Weight |
|---|---|
| 2-methyl 1,3-propane diol | 19.9 |
| trimethylolpropane | 3.01 |
| isophthalic acid | 14.35 |
| dibutyl tin oxide (catalyst) | 0.06 |
| maleic anhydride | 8.35 |
| phthalic anhydride | 7.3 |
| Aromatic 100 | 7.79 |
| phosphoric acid (85%) | 1.11 |
| water | 0.08 |
| 2-butoxyethanol | 4.26 |
| monobutyl ether of diethylene | 33.8 |
| glycol | |

### Phosphatized Epoxy

The phosphatized epoxy feathering reducing agent was prepared as follows:

16.81 g of 85 percent orthophosphoric acid and 28.24 g of butanol was added to a flask. The mixture was heated to 230 F. (110° C.) under nitrogen inert blanket. When the temperature was reached, the nitrogen blanket was turned off and a premix of 83.19 g of diglycidyl ether, cyclohexanedimeth and 45.06 g of butanol was fed over a period of 2 hours and 10 minutes. The batch temperature was maintained below 245° F. (118° C.) during the addition. After the completion of the feed, 4.36 g of butanol was added to the flask and temperature was reduced to 219° F. (104° C.) and held for additional 2 hours. Additional 22.34 g of butanol was then added to the flask.

TABLE 10
phosphatized epoxy

| Type | Component | Amount |
|---|---|---|
| Reactant | Diglycidyl Ether, cyclohexanedimeth | 83.19 |
| Reactant | Orthophosphoric acid (85%) | 16.81 |
| Solvent | Normal Butyl Alcohol | 100.0 |

### Acid-Functional Acrylic

The acid-functional acrylic was prepared as follows. [324] 374 g Dowanol PM (available from Dow) and 150 g isopropanol were charged to a reaction vessel equipped with an agitator, a nitrogen blanket and a condenser set up and heated to reflux at 100° C. Then, the monomers as provided in Table 2, 12.27 g t-butyl peroctoate and 17.76 g Dowanol PM were charged to the reaction vessel over a time period of 180 minutes with stirring. After this time, 17.05 g Dowanol PM was added and the reaction mixture was held for 15 minutes at 100° C. Then, 50 vol % of a mixture of 2.18 g t-butyl peroctoate and 22.93 g Dowanol PM was added and the reaction mixture was held for a further 60 minutes. After this time, the remaining 50 vol % of the t-butyl peroctoate/Dowanol PM mixture was added along with a 13.95 g Dowanol PM rinse and the reaction mixture was once again held for 60 minutes. Then, the heat was removed, 164.01 g Dowanol PM was added to the reaction vessel and the reaction mixture was allowed to cool to 35° C.

The resultant acrylic resins were then removed from the reaction vessel by pouring into a glass jar. The acid number of the resultant acrylic resins is provided in Table 11.

TABLE 11
acid functional acrylic

| | | | | Solvent | Acid Number |
|---|---|---|---|---|---|
| MAA | AA | MA | BMA | Composition | (mg KOH/g) |
| 9.03% | 21.03% | 36.61% | 33.33% | Dowanol PM | 219 |
| | | | | Isopropanol | |

For the avoidance of doubt, MAA is methacrylic acid, AA is acrylic acid, MA is methacrylate, and BMA is butyl methacrylate.

### Phosphatized Epoxide Acrylic

A phosphatized epoxide acrylic was prepared as follows.

Epoxide functional acrylic resin. To a suitable reaction vessel equipped with a reflux condenser, thermocouple and adaptor for nitrogen blanket, charge #1 of Table 12 (solvent mixture) was loaded into a vessel and heated to 100-105° C. Charge #3 (GMA containing monomer mixture GMA/STY/HEMA) and charge #2 (initiator) were added to the vessel simultaneously over 3 hours. Upon completion of polymerization of feeds, additional initiator was added as charge #4 and the reaction was continued for another two hours to complete the conversion of residual monomers. After the hold, heat was discontinued and charge #5 (butyl cellosolve) was added to adjust the solids to 62.1%. The epoxy equivalent weight (EEW) of the solution mixture was determined to be 3,000 on solution. The epoxide functional acrylic had a Mw of 24,304 Da and a Mn of 7,834 Da.

### Table 12—GMA Acrylic Resin

Phosphatized epoxide acrylic. The epoxide functional polymer thus formed was then reacted with phosphoric acid. To a suitable reaction vessel equipped with a reflux condenser, thermocouple and adaptor nitrogen blanket, charge #1 of Table 13 (solvent mixture) was loaded into a vessel followed by charge #2 (phosphoric acid/butyl cellosolve mixture) and the batch was heated to 12000. When the batch reached the desired temperature, charge #3 (epoxide functional acrylic) was added over a period of 1 hour. After addition was complete, charge #4 was added as rinse and the batch was reheated to 12500 to hold for 2 hours. After hold, the batch was cooled to 10000 and charge #5 of DI water was added in drops. After addition was complete, the batch was held additional two hours under reflux. After the two hour hold, the batch was cooled and EEW of mixture was determined to confirm that the phosphotization of epoxy was completed. The resin EEW was >100,000.

TABLE 13
phosphatized epoxide acrylic

| Charge | Component | Weight % |
|---|---|---|
| #1 | butanol | 280 |
| | carbitol | 120 |
| [symbol] | [symbol] | [symbol] |
| #1 | [symbol] | [symbol] |
| #3 | [symbol] | [symbol] |
| [symbol] | [symbol] | [symbol] |
| | [symbol] | [symbol] |
| #5 | [symbol] | [symbol] |
| #3 | hydroxyethylmethacrylate (HEMA) | 759.15 |
| | styrene | 894.31 |
| | GMA | 153.88 |
| #4 | butyl alcohol | 34.20 |
| | t-butyl peroctoate | 38.56 |
| #5 | butyl cellosolve | 78.65 |

[symbol]

indicates data missing or illegible when filed

### COATING COMPOSITIONS

The compositions of Comparative Examples 2 to 4 and Examples 5 to 8 were prepared by combining the materials of Table 14 under mixing for 15 minutes with a mixing blade.

Coated panels were obtained by drawing the coating composition over trivalent chromium pretreated NR6207 aluminum panels (AA5182 Alloy) using a wire wound rod to obtain dry coating weight of approximately 6.5 to 7.5 mg/square inch (msi). Coated panels were then immediately placed into a three-zone, gas-fired, conveyor oven for 10 seconds and baked to a peak metal temperature of 465° F. (240.5° C.).

TABLE 14
Coating compositions

| | Solid | Comp. | | | | | | Comp. | Comp. |
|---|---|---|---|---|---|---|---|---|---|
| | (%) | Ex. 2 | Ex. 5 | Ex. 6 | Ex. 7 | Ex. 8 | Ex. 9 | Ex. 3 | Ex. 4 |
| Polyester 2 | 40 | 64.95 | 64.89 | 64.70 | 61.65 | 56.70 | 61.05 | 64.70 | 64.13 |
| Acidic polyester additive | 50 | 2.63 | 2.63 | 2.63 | 2.63 | 2.63 | 2.47 | 2.63 | 2.63 |
| Maprenal bf 892/68B¹ | 68 | 7.71 | 7.71 | 7.71 | 7.71 | 7.71 | 7.25 | 7.71 | 7.71 |
| Butyl Glycol Acetate | 0 | 6.95 | 6.95 | 6.95 | 6.95 | 6.95 | 6.53 | 6.95 | 6.95 |
| Aromatic-150 | 0 | 11.52 | 11.56 | 11.67 | 12.79 | 13.17 | 10.85 | 11.67 | 12.01 |
| Aromatic-100 | 0 | 3.02 | 3.02 | 3.02 | 3.02 | 3.02 | 2.84 | 3.02 | 3.02 |
| Versamid 115 | 100 | | 0.03 | | | | | | |
| Dicyandiamide | 100 | | | 0.10 | | | | | |
| Phosphatized epoxy | 65 | | | | 2.03 | | | | |
| Acid-functional acrylic | 50 | | | | | 6.60 | | | |
| Phosphatized epoxide acrylic | 35 | | | | | | 6.0 | | |
| Polyphosphoric acid² | 100 | | | | | | | 0.10 | |
| Zinc octoate | 100 | | | | | | | | 0.33 |
| MD471 Carnauba³ | 9 | 3.03 | 3.03 | 3.03 | 3.03 | 3.03 | 2.85 | 3.03 | 3.03 |
| Lanco tf 1780 ef⁴ | 100 | 0.12 | 0.12 | 0.12 | 0.12 | 0.12 | 0.11 | 0.12 | 0.12 |
| DYNOADD F-300⁵ | 100 | 0.07 | 0.07 | 0.07 | 0.07 | 0.07 | 0.07 | 0.07 | 0.07 |

¹a methylol type, n-butylated benzoguanamine formaldehyde resin. 68% is dissolved in n-butanol. From INEOS
²CAS 8017-16-1
³a carnauba wax from Michelman.
⁴PTFE Modified Polyethylene Wax from Lubrizol
⁵a polymeric, non-silicone flow and wetting additive from Dynoadd

Feathering: The feathering property of the coatings was evaluated by following test protocol 1 described above.

Blush and Adhesion: Coatings were evaluated for their ability to resist blushing and to adhere to the aluminum panels in deionized water retort test. Coated panels were cut into 2 inch by 4 inch pieces, half immersed into deionized water, and then placed in a steam retort for 30 minutes at 250° F. Panels were then cooled in deionized water, dried, and immediately rated for blush and adhesion. Blush was rated visually using a scale of 1-10 where a rating of “10” indicates no blush and “0” indicates complete whitening of the film. Adhesion test was performed according to ASTM D 3359 Test Method B using Scotch 610 tape, and rated using a scale of 0-100% where a rating of “100%” indicates no adhesion failure and “0” indicates complete adhesion failure. Results of these tests are reported in Tables 15 and 16.

Wedge Bend: Flexibility of the coatings was evaluated using a wedge bend test. Coated panels were cut into 2 inch by 4 inch pieces, with the substrate grain running perpendicular to the long length of the cut panel. They were then bent over a ⅛ inch metal rod along the long length of the panel with the coated side facing out. Bent coupons were then placed onto a block of metal where a wedge was pre-cut out of it with a taper of 0 to ⅛ inch along a 4 inch length. Once placed in the wedge, each bent coupon was struck with a block of metal which weighed 4 pounds from a height of 12 inches to form a wedge where one end of the coated metal impinged upon itself and a ⅛ inch space remained on the opposite end. Wedge bent panels were then placed into an aqueous solution of copper sulfate and hydrochloric acid for one minute to purposely etch the aluminum panel in areas where the coatings failed and cracked. The etched wedge bent panels were then examined through a microscope at 1 Ox power to determine how far from the impinged end along the bent radii did the coating crack. Flexibility results are reported as either the length of cracked area from the impinged end or the percentage of cracked area versus total length of the wedge bent panel. Results of these tests are reported in Table 16.

TABLE 15
coating properties

| | Comp. | | | | | | Comp. | Comp |
|---|---|---|---|---|---|---|---|---|
| | Ex. 2 | Ex. 5 | Ex. 6 | Ex. 7 | Ex. 8 | Ex. 9 | Ex. 3 | Ex. 4 |
| Feathering (mm) | 6.52 | 0.00 | 0.00 | 0.47 | 0.17 | 0.72 | 7.00 | 4.42 |
| Adhesion (%) | 0 | 100 | 100 | 100 | 100 | — | 0 | 10 |

TABLE 16
coating properties

| | Comp. | | | Comp. | Comp. |
|---|---|---|---|---|---|
| | Ex. 2 | Ex. 5 | Ex. 6 | Ex. 3 | Ex. 4 |
| Blush | 7 | 7 | 6 | 2 | 3 |
| Wedge bend | 10.12 | 9.10 | 13.11 | 24.28 | 43.52 |

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A coating composition comprising:
a. a polyester binder material; and
b. a feathering reducing agent, selected from
i. an acrylic feathering reducing agent comprising a functional group selected from hydroxyl, epoxide, phosphatized epoxide and/or acid-functional;
ii. a hydroxy-functional polyester feathering reducing agent;
iii. a feathering reducing agent comprising a functional group selected from amine, amide, imine and/or nitrile;
iv. a phosphatized epoxy feathering reducing agent;
v. a phenolic resin feathering reducing agent; and/or
vi. a feathering reducing agent comprising an oxazolyl functional group.

2. (canceled)

3. A coated substrate comprising a coating extending over at least a part of the substrate, wherein the coating is obtainable from a coating composition comprising:
a. a polyester binder material; and
b. a feathering reducing agent, selected from
i. an acrylic feathering reducing agent comprising a functional group selected from hydroxyl, epoxide, phosphatized epoxide and/or acid-functional;
ii. a hydroxy-functional polyester feathering reducing agent;
iii. a feathering reducing agent comprising a functional group selected from amine, amide, imine and/or nitrile;
iv. a phosphatized epoxy feathering reducing agent;
v. a phenolic resin feathering reducing agent; and/or
vi. a feathering reducing agent comprising an oxazolyl functional group
optionally, wherein the coated portion of the substrate comprises a pretreatment layer, wherein the pretreatment layer is obtainable from a pretreatment composition that comprises a trivalent chromium compound.

4. (canceled)

5. A package coated at least in part with a coating composition comprising:
a. a polyester binder material; and
b. a feathering reducing agent, selected from
i. an acrylic feathering reducing agent comprising a functional group selected from hydroxyl, epoxide, phosphatized epoxide and/or acid-functional;
ii. a hydroxy-functional polyester feathering reducing agent;
iii. a feathering reducing agent comprising a functional group selected from amine, amide, imine and/or nitrile;
iv. a phosphatized epoxy feathering reducing agent;
v. a phenolic resin feathering reducing agent and/or
vi. a feathering reducing agent comprising an oxazolyl functional group
optionally wherein the coated portion of the substrate comprises a pretreatment layer, wherein the pretreatment layer is obtainable from a pretreatment composition that comprises a trivalent chromium compound.

6. (canceled)

7. (canceled)

8. A composition according to claim 1, wherein the composition is an aqueous coating composition.

9. A composition according claim 1, wherein the composition is an organic solvent borne coating composition.

10. A composition according claim 1, wherein the polyester binder material comprises a polyester obtainable by polymerizing a polyacid component with a polyol component.

11. The composition according to claim 10, wherein the polyacid comprises maleic acid; fumaric acid; itaconic acid; adipic acid; azelaic acid; succinic acid; sebacic acid; glutaric acid; decanoic diacid; dodecanoic diacid; phthalic acid; isophthalic acid; 5-tert-butylisophthalic acid; tetrachlorophthalic acid; tetrahydrophthalic acid; trimellitic acid; naphthalene dicarboxylic acid; naphthalene tetracarboxylic acid; terephthalic acid; hexahydrophthalic acid; methylhexahydrophthalic acid; dimethyl terephthalate; cyclohexane dicarboxylic acid; chlorendic anhydride; 1,3-cyclohexane dicarboxylic acid; 1,4-cyclohexane dicarboxylic acid; tricyclodecane polycarboxylic acid; endomethylene tetrahydrophthalic acid; endoethylene hexahydrophthalic acid; cyclohexanetetra carboxylic acid; cyclobutane tetracarboxylic; and/or a monomer having an aliphatic group containing at least 15 carbon atoms; esters and anhydrides of all the aforementioned acids.

12. (canceled)

13. (canceled)

14. The composition according claim 10, wherein the polyol comprises an alkylene glycol, such as ethylene glycol; propylene glycol; diethylene glycol; dipropylene glycol; triethylene glycol; tripropylene glycol; hexylene glycol; polyethylene glycol; polypropylene glycol and neopentyl glycol; hydrogenated bisphenol A; cyclohexanediol; propanediols including 1,2-propanediol; 1,3-propanediol; butyl ethyl propanediol; 2-methyl-1,3-propanediol; and 2-ethyl-2-butyl-1,3-propanediol; butanediols including 1,4-butanediol; 1,3-butanediol; and 2-ethyl-1,4-butanediol; pentanediols including trimethyl pentanediol and 2-methylpentanediol; cyclohexanedimethanol; hexanediols including 1,6-hexanediol; 2,2,4,4-tetraalkylcyclobutane-1,3-diol (TACD), such as 2,2,4,4-tetramethylcyclobutane-1,3-diol (TMCD), 2,2,4-trimethyl-1,3-pentanediol (TMPD), caprolactonediol (for example, the reaction product of a reaction mixture comprising epsilon-capro lactone and ethylene glycol); hydroxyalkylated bisphenols; polyether glycols, for example, poly(oxytetramethylene) glycol; trimethylol propane; pentaerythritol; di-pentaerythritol; trimethylol ethane; trimethylol butane; dimethylol cyclohexane; bio-derived polyols such as glycerol, sorbitol and isosorbide; and/or a monomer having an aliphatic group containing at least 15 carbon atoms.

15. (canceled)

16. (canceled)

17. The composition according claim 1, wherein the polyester binder material comprises an acrylic polyester resin.

18. The composition according to claim 17, wherein the acrylic polyester resin is obtainable by grafting an acrylic polymer and a polyester resin, wherein the polyester resin is obtainable by polymerizing:
i) a polyacid component with
ii) a polyol component
and wherein one of the polyacid component or the polyol component comprises a functional monomer operable to impart functionality on to the polyester resin, such that an acrylic polymer may be grafted with the polyester resin via the use of said functionality.

19. The composition according to claim 18, wherein the functional monomer of the polyester resin of the acrylic polyester resin comprises maleic acid, maleic anhydride and/or fumaric acid.

20. The composition according to claim 18, wherein the acrylic polymer comprises acrylic monomers selected from methyl (meth)acrylate, ethyl (meth)acrylate, butyl (meth)acrylate, cyclohexyl (meth)acrylate; allyl (meth)acrylate; isobornyl (meth)acrylate, hydroxyethyl (meth)acrylate, 2-ethylhexyl (meth)acrylate, (meth)acrylic acid, dimethylamino ethyl methacrylate, butylamino ethyl (meth)acrylate, and/or HEMA phosphate (such as ethylene glycol methacrylate phosphate).

21. (canceled)

22. The composition according claim 1, wherein the composition comprises ≥40% of the polyester material by total solid weight of the composition, such as ≥50 wt %, or ≥60 wt %.

23-91. (canceled)

92. The composition according claim 1, wherein a coating formed from the coating composition has a feathering of ≤0.8 mm.

93. The composition according claim 1, wherein a coating formed from the coating composition; has a wedge bend of ≤30 mm.

94. The composition according claim 1, wherein a coating formed from the coating composition has a blush of ≥4.

95. The composition according claim 1, wherein a coating formed from the coating composition has a adhesion of ≥90.

96. The composition according claim 1, wherein the composition comprises an epoxy resin.

97. (canceled)

98. The composition according claim 1, wherein the composition comprises a crosslinking material.

99. (canceled)

100. The package according to claim 5, wherein the package is a food and/or beverage package.

101-105. (canceled)
